(19) United States
(12) Patent Application Publication
(10) Pub. No.: US 2021/0371673 A1
(43) Pub. Date: Dec. 2, 2021

(54) COATED BODY AND COATING COMPOSITION

(71) Applicant: TOTO LTD., Kitakyushu-shi (JP)

(72) Inventors: Shunsuke NISHINO, KITAKYUSHU-SHI (JP); Hiroyuki FUJII, KITAKYUSHU-SHI (JP); Takeshi IKEDA, KITAKYUSHU-SHI (JP); Aiko ITAMI, KITAKYUSHU-SHI (JP); Makoto HAYAKAWA, KITAKYUSHU-SHI (JP); Akira SHIMAI, KITAKYUSHU-SHI (JP); Keisuke SUZUKI, KITAKYUSHU-SHI (JP)

(21) Appl. No.: 17/214,118

(22) Filed: Mar. 26, 2021

Related U.S. Application Data
(63) Continuation of application No. PCT/JP2020/009574, filed on Mar. 6, 2020.

(30) Foreign Application Priority Data
Mar. 6, 2019 (JP) 2019-041055

(51) Int. Cl. C09D 5/14; A01N 59/16; C09D 1/00; B01J 23/10; B01J 35/00

(52) U.S. Cl. CPC C09D 5/14; A01N 59/16; C08K 3/22; B01J 23/10; B01J 35/004; C09D 1/00

(57) ABSTRACT

A coated body is obtained by providing a surface layer of a coating composition on a substrate, wherein the surface layer contains cerium oxide particles having an oxygen-deficient fluorite structure and having an average crystallite diameter of 10 nm or less, and the cerium oxide particles have, in a Raman spectrum, a peak that is attributed to the F2g vibration mode of a Ce—O bond and that is offset by more than 2 cm⁻¹ toward the lower wavenumber from a peak that is attributed to the F2g vibration mode of a Ce—O bond and that is obtained when a standard substance is measured. This coated body significantly suppresses fungal growth inside of a door and algal growth outside of a door for a long period of time.

### TECHNICAL FIELD

The present invention relates to a coated body and a coating composition, especially a coated body and a coating composition that have a function of suppressing fungal growth in the use inside of a door and a good function of suppressing fungal growth and/or algal growth outside of a door.

### BACKGROUND ART

A coated body having photocatalytic particles on a surface layer is known as a material that can express an antifungal function and an anti-algal function by responding to light.

Anatase-type titanium oxide particles have been widely used as the photocatalytic particles. The anatase-type titanium oxide particles have band gap of 3.2 eV between the valence band formed by the O (2p) orbit and the conduction band formed by the Ti (3d); so that, when UV light with the wavelength of 387 nm or less is irradiated thereto, an oxidation-reduction reaction based on interband transition leads to expression of the antifungal function and the anti-alga function.

Also, photocatalysts that can cause a photocatalytic reaction by visible light have been known. A typically known substance is rutile-type titanium oxide. The rutile-type titanium oxide has band gap of 3.0 eV between the valence band formed by the O (2p) orbit and the conduction band formed by the Ti (3d); so that, not only UV light but also part of visible light, the light with the wavelength of 400 to 413 nm can be utilized.

On the other hand, cerium oxide is known as an UV absorber. As the band gap between the O (2p) orbit and the Ce (4f 0) orbit is 3.1 eV, it can efficiently absorb UV light less than 400 nm.

In recent years, the photocatalytic characteristics of cerium oxide have also been studied. A study of the cerium oxide having oxygen defects describes that photocatalytic cerium oxide utilizes the light of less than 500 nm by the interband transition in which the band gap is narrowed (NPTL 1).

On the other hand, the antifungal activity of cerium oxide has been known. Patent Literature 2 discloses “a hydrophilization agent comprising water and one, or two or more selected from hardly water-soluble cerium compounds (A) dispersed in the water.” It is also disclosed that the cerium oxide having the particle diameter of 0.01 to 2 μm can be used as the hardly water-soluble cerium compounds.

### CITATION LIST

### Patent Literature

PTL 1: JP 2000-237597 A
PTL 2: JP 2012-87213 A
PTL 3: JP 2011-56471 A
PTL 4: JP 2002-88275 A
PTL 5: JP. 2018-145429 A
PTL 6: JP 2008-264747 A

### Non-Patent Literature

NPTL 1: Chem. Cat. Chem., 2018, Vol. 10, 1267-1271

### SUMMARY OF THE INVENTION

### Technical Problems

The coated body having the anatase-type titanium oxide particles in the surface layer may be inferior in expressing antifungal function inside of a door because the UV amount present inside is insufficient in many cases.

With the conventional photocatalysts that are excited by visible light, such as a coated body having rutile-type titanium oxide in the surface layer, the antifungal function cannot be expressed sufficiently inside of a door because usable visible light region is limited and thereby insufficient. In addition, because it does not have a high photocatalytic activity like the anatase-type titanium oxide, the antifungal function and the anti-algal function thereof cannot be always expressed sufficiently even outside of a door.

Furthermore, when cerium oxide is used, even if the coated body is formed by using the photocatalytic cerium oxide particles that can utilize light with the wavelength of 500 nm or less by narrowing the band gap by introducing trivalent cerium (Ce(III)) or the oxygen defects, it is sometimes difficult to obtain the sufficient antifungal property under the visible light such as a white light source.

The present invention was attempted in light of the circumstances described above. Therefore, the object thereof is to provide a coated body and a coating composition that can express a function of suppressing fungal growth even inside of a door as well as an excellent function of suppressing fungal growth and/or algal growth outside of a door for a long period of time.

### Solution to Problems

We have confirmed that a coated body having a surface layer that includes specific cerium oxide particles can eminently suppress not only fungal growth by visible light, UV light, sunlight during day time in an outdoor environment, or an indoor illumination in an indoor environment in a living space, but also algal growth outside of a door.

Therefore, the coated body according to the present invention is a coated body for suppressing fungal growth and/or algal growth after their attaching to a surface thereof, which comprises a substrate and a surface layer formed on the substrate; wherein the surface layer comprises cerium oxide particles having an oxygen-deficient fluorite structure and having an average crystallite diameter thereof in a range of 10 nm or less; and the cerium oxide particles have, in a Raman spectrum, a peak attributed to an F_{2g} vibration mode of a Ce—O bond is shifted toward a lower wavenumber by more than 2 cm⁻¹ from a peak attributed to the F_{2g} vibration mode of the Ce—O bond obtained by measurement of a standard substance; and wherein the coated body can eminently suppress not only fungal growth inside of a door but also algal growth outside of a door.

Also, the coating composition according to the present invention is a coating composition comprising cerium oxide particles having an oxygen-deficient fluorite structure and having an average crystallite diameter thereof in a range of 10 nm or less; wherein the cerium oxide particles, have, in a Raman spectrum, a peak attributed to an F_{2g} vibration mode of a Ce—O bond is shifted toward a lower wavenumber by more than 2 cm⁻¹ from a peak attributed to the F_{2g} vibration mode of the Ce—O bond obtained by measurement of a standard substance; and

wherein a coated body which comprises a surface layer formed by applying the coating composition on a substrate can suppress fungal growth and/or alga growth after their attaching to a surface of the coated body.

Therefore, according to the present invention, there is provided a use of the coated body according to the present invention to suppress fungal growth and/or algal growth after their attaching to the surface thereof.

Also, there is provided a use of the coating composition according to the present invention in production of the coated body capable of suppressing fungal growth and/or algal growth after their attaching to the surface thereof.

It is considered that the mechanism of suppressing fungal growth on the coated body is totally different from the functions of conventional photocatalysts and antifungal agents. Hereinafter, the expected functions thereof will be described.

For example, in the technology using a conventional photocatalyst, when fungal spores were affected by photocatalyst, the cell wall and the cell membrane of fungal spores are damaged by action of active species generated by photocatalytic excitation. As a result of that, the fungal spores are killed.

Also, the antifungal agent using a cerium compound as a conventional technology causes a cerium metal ion, which is a heavy metal ion, to act to a fungal cell so as to suppress fungal growth. In this case, too, the fungal spore is killed.

On the other hand, the action by the coated body of the present invention does not damage the cell wall and cell membrane of the fungal spores. In fact, in order to experimentally confirm this, a culturing experiment was carried out by transferring the spores after action to the coated body of the present invention to a culture medium suitable for germination and growth, the fungal spores germinated and grew to form colonies. From this actual observation, it can be concluded quite possibly that the surface of the coated body of the present invention has no action to kill the spores. This is because, if the spores dies out, usually it cannot form the colonies. Nevertheless, to our surprise, through observing the degree of fungal growth and algal growth for a long period of time, it was found that the coated body of the present invention can suppress the growth more effectively than conventional technologies.

In the present invention, after visible light or light including UV light is irradiated to the surface layer, the cell wall and cell membrane of the fungal spores are hardly damaged as mentioned above, but the ATP value can be suppressed to a low value; namely, metabolism is suppressed. It was also observed that germination was suppressed.

In the present invention, although the reason for realization of the above-mentioned effect is not clear yet, it is presumed as follows. However, the following explanation is only a hypothesis; so the present invention is not restricted at all by the hypothesis described below.

In the present invention, the cerium oxide particles have oxygen defects. In addition, in the Raman spectra of the cerium oxide particles of the present invention, a peak attributed to an F_{2g} vibration mode of a Ce—O bond is shifted toward a lower wavenumber by more than 2 cm′ from a peak attributed to the F_{2g} vibration mode of the Ce—O bond obtained by measurement of a standard substance; and on top of this, the crystal has the structural defects as many as possible within the range capable of keeping a fluorite structure. On the surface of the cerium oxide particles like this, presumably, the oxygen absorbed thereto is activated (probably to a state of peroxide or the like). Then, presumably, the cerium oxide particles like this give stress factors that don't kill the fungal spores and mycelia.

When large stress like this is generated, the spore prioritizes to remove this stress. Because of this, it is presumed that an energy-metabolizing reaction and a germination reaction are suppressed thereby leading to suppression of the fungal growth inside of a door and of the algal growth outside of a door.

The reason that the present invention is superior, in the property to suppress fungal growth and algal growth for a long period of time, to the technologies using conventional photocatalysts and antifungal agents by cerium compounds is presumably as follows.

According to the reaction of the conventional photocatalyst alone, an oxidation-reduction reaction is caused by photo-excitation due to the photocatalyst thereby generating strong oxidation power. Because of this, the cell wall and the cell membrane are damaged thereby leading to the death of the fungi. The protein in the dead fungi is oozed out from the cell tissue because the cell membrane is damaged; and this protein is remained and accumulated. This becomes the base and nutrition source of the fungal spores that are newly attached from outside thereby leading to a gradual increase in the accumulated layer including fungi, bacteria, etc., this in turn resulting in formation of the portion to which light cannot reach readily. So, it is presumed that especially inside of a door or the like, the effect can be gradually decreased on a long-term basis.

In the antifungal agent by a cerium compound, the cerium ion, which is a heavy metal ion, is caused to act to fungi; in this case, too, death of the fungi is basically resulted. Therefore, similar to the photocatalyst case, it is presumed that the phenomenon of gradual decrease in the effect is resulted.

On the other hand, in the present invention, the fungal spores are not killed. Therefore, because the phenomenon of gradual decrease in the effect does not occur, this is excellent in the fungal growth for a long period of time.

The study of the mechanism of algal attachment outside of a door by a close observation revealed that, as shown in Examples described later, the fungal spores germinate (at first), and the fungal mycelia extend and branch, and after of that, the algae attach to that mycelia and grow proliferously. Accordingly, it is presumed that as a result of suppressing fungal growth, algal growth on the coated body outside of a door could be suppressed as well.

According to a preferred embodiment of the present invention, the cerium oxide particles further have a peak attributed to O₂²⁻ in a Raman spectrum thereof. With this, the suppressing effects of the fungal growth inside of a door as well as the algal growth outside of a door for a long period of time can be expressed even more.

In the invention described above, the reason for realization of these effects is not yet clear; but it is presumed as follows. The following explanation is only a hypothesis; so, the present invention shall not be restricted at all by the following hypothesis.

In the cerium oxide particle having the peak attributed to O₂²⁻, the adsorbed oxygen exists in the activated state, as this is going to be described later. In this embodiment, it is presumed that the adsorbed and activated oxygen species give some kind of stronger stress to the fungal spores.

Because of this, presumably the spores work some kind of protection function to eliminate the stress thereby suppressing the energy metabolism and germination; as a result, it is presumed that the fungal growth inside of a door and the algal growth outside of a door can be suppressed for a long period of time.

According to the preferred embodiment of the present invention, visible light is irradiated to the surface layer, and the coated body is used under being exposed to an environment in which the fungal spores is attached to the surface thereof.

The inventor of the present invention found that after irradiation of the visible light, the cell wall and cell membrane of the fungi were hardly damaged but the ATP value could be suppressed to a low value, and that, as a result, due to irradiation of the visible light, the suppressing effects of the fungal growth inside of a door and of the algal growth outside of a door could be enhanced for a long period of time.

Accordingly, in this embodiment, the suppressing effects of the fungal growth inside of a door and of the algal growth outside of a door for a long period of time can be expressed even more.

In the invention described above, the reason for realization of these effects is not yet clear; but it is presumed as follows. The following explanation is only a hypothesis; so, the present invention shall not be restricted at all by the following hypothesis.

Cerium oxide is known as an UV absorber. Because the band gap between the valence band formed by O (2p) orbit and the conduction band formed by Ce (4f0) orbit is 3.1 eV, cerium oxide absorbs UV light with the wavelength of less than 400 nm. In recent years, the photocatalytic characteristics of cerium oxide have also been studied. In the study of the cerium oxide having oxygen defects, it is reported that photocatalytic cerium oxide has narrowed band gap and utilizes the light with the wavelength of less than 500 nm by the interband transition. However, the suppression of the fungal growth has not been studied from a viewpoint of cerium oxide as the photocatalyst. Nevertheless, many are reported with regard to the conventional antifungal function of titanium oxide as the photocatalyst, in which it is reported that strong oxidation power of the photocatalyst oxidatively decomposes the fungi thereby damaging and killing the fungi.

Then, in this embodiment, surprisingly, the damage and death of the fungi by the strong oxidation, observed in the case of photocatalytic titanium dioxide, are not observed.

This is presumably because when visible light is irradiated to the cerium oxide crystal with a type of an oxygen-deficient fluorite, some kind of active species generated due to the energy transition intervened by a donor level or the electron excitation from donor level corresponding to the electron excitation from donor level corresponding to the energy difference between the Ce (4f1) state and the Ce (4f0) state is taken onto or into the cerium oxide crystal. When the active oxygen species is generated, this is taken onto or into the crystal surface as oxygen. When positive holes are generated, these are consumed in the energy transition reaction from the trivalent cerium (Ce(III)) to the tetravalent cerium (Ce(IV)) on the crystal surface, resulting in the state in which the crystal surface attracts the oxygen much more. In any of the reactions, it is presumed that the amount of oxygen on the surface of the cerium oxide crystal is increased. Because the energy difference between the Ce (4f1) state and the Ce (4f0) state is about 1.6 eV, even when the light with the wavelength of more than 500 nm, e.g., about 760 nm, is irradiated, in principle, there is a possibility of obtaining the growth-suppressing effect mentioned above.

It is presumed that when the phenomena mentioned above act directly or indirectly to the fungi, the stress exerted by cerium oxide on fungi increases; as a result, the suppressing effect of the fungal growth inside of a door and the algal growth outside of a door can be expressed even more for a long period of time.

In the preferred embodiment of the present invention, light including UV light is irradiated to the surface layer, and the coated body is used under being exposed to an environment in which the fungal spores attach to the surface thereof.

The inventor of the present invention found that in the coated body of the present invention, after the light including the UV light was irradiated, the cell wall and cell membrane of the fungi were hardly damaged, but the ATP value of the fungi could be suppressed to a low value, and that, as a result, due to irradiation of the light including the UV light, the suppressing effects of the fungal growth inside of a door and of the algal growth outside of a door could be enhanced for a long period of time, and that these effects were higher as compared with them by the irradiation of visible light.

Accordingly, in this embodiment of the present invention, the suppressing effect of the fungal growth inside of a door and the algal growth outside of a door can be expressed even more for a long period of time.

In the invention described above, the reason for realization of these effects is not yet clear; but it is presumed as follows. The following explanation is only a hypothesis; so, the present invention shall not be restricted at all by the following hypothesis.

In this embodiment, too, the damage due to the oxidative decomposition of the fungi caused by strong oxidation power generated by the photo-excitation reaction of the photocatalyst is not observed.

This is presumably because, similarly to the case of the visible light irradiation, active species generated when the light including the UV light is irradiated to the cerium oxide crystal with a type of an oxygen-deficient fluorite are taken onto or into inside the cerium oxide crystal. When the active oxygen species is generated, this is taken onto or into the crystal surface as oxygen. When positive holes are formed, these are consumed in the energy transition reaction from the trivalent cerium to the tetravalent cerium on the crystal surface, resulting in the state in which the crystal surface withdraws the oxygen much more. In any of the reactions, it is presumed that the amount of oxygen on the surface of the cerium oxide crystal is increased.

From the mechanism described above, it is presumed that the stress of the cerium oxide to the fungi increases; as a result, the suppressing effect of the fungal growth inside of a door and the algal growth outside of a door can be expressed even more for a long period of time.

The reason for a superior effect of irradiation of the UV light in this embodiment to the irradiation of the visible light is presumably as follows. Namely, by utilizing the interband transition between the valence band based on the more stable O (2p) orbit and the conductive band based on the Ce (4f0), the state is resulted in which the amount of oxygen on the surface of the cerium oxide crystal increases stably and more abundantly.

### Advantageous Effects of the Invention

According to the present invention, a coated body and a coating composition that can express a function of suppressing fungal growth even inside of a door as well as an excellent function of suppressing fungal growth and/or algal growth outside of a door for a long period of time can be provided.

### BRIEF DESCRIPTION OF THE DRAWINGS

FIG. 1 is an optical microscopic picture illustrating the mycelial growth degree “0: spores are in the ungerminated state”.

FIG. 2 is an optical microscopic picture illustrating the mycelial growth degree “1: part of spores are germinated, but the length of the mycelia is several 100 μm or less”.

FIG. 3 is an optical microscopic picture illustrating the mycelial growth degree “2: germination of spores is recognized, and the mycelia partially extend several 100 μm or more”.

FIG. 4 is an optical microscopic picture illustrating the mycelial growth degree “3: most of the spores are germinated, and the mycelia extend entirely”.

FIG. 5 is a graph illustrating the relationship between the ATP value and the fungal growth in the laboratory test.

FIG. 6 is a graph illustrating the relationship between the laboratory test and the outdoor test in the ATP value.

FIG. 7 is a graph illustrating the relationship between the ATP value and the color difference.

### DESCRIPTION OF THE EMBODIMENTS

Coated Body

The coated body of the present invention is the coated body which can suppress fungal growth and/or algal growth after their attaching to the surface thereof, characterized by that; this has a substrate and a surface layer formed on the substrate; the surface layer thereof is formed of cerium oxide particles having an oxygen-deficient fluorite structure and having an average crystallite diameter thereof in a range of 10 nm or less; in a Raman spectrum of the cerium oxide particles, a peak attributed to an F_{2g} vibration mode of a Ce—O bond is shifted toward a lower wavenumber by more than 2 cm⁻¹ from a peak attributed to the F_{2g} vibration mode of the Ce—O bond obtained by measurement of a standard substance; and fungal growth and/or algal growth after their attaching to the surface of the coated body can be suppressed.

In one embodiment of the coated body according to the present invention, preferably, visible light is irradiated to the surface layer, and the coated body is used under being exposed to an environment in which a fungal spore is attached to the surface layer.

In another embodiment of the coated body, preferably, light including UV light is irradiated to the surface layer, and the coated body is used under being exposed to an environment in which fungal spores attach to the surface layer.

Here, the visible light is the light with the wavelength of 400 nm or more to less than 1000 nm, while the light with the wavelength of 400 nm to 760 nm is preferable in the present invention.

The light source of an artificial illumination such as an indoor illumination and a street lamp may be used. The embodiment thereof includes indirect irradiation of sunlight or an artificial illumination that irradiate UV light to the coated body of the present invention. Here, the indirect light means the light that is reflected, scattered, or transmitted by an arbitrary material, i.e., the light whose UV strength is reduced because of these actions.

Examples of the indoor illumination that can be suitably used include an incandescence lamp and a white LED.

Examples of the embodiment include: a use in housing equipment such as a wall, a window, a floor, and a ceiling in a car space and an indoor space to be illuminated occasionally but not illuminated during sleeping or not in use time thereof; and a use in an outdoor environment indirectly exposed to a sunlight.

The light including the UV light is preferably the light with the wavelength range of more than 250 nm to less than 400 nm, while more preferably with the wavelength range of more than 300 nm to less than 400 nm. The usable light source is any of artificial illuminations such as an UV LED, a white fluorescent light, and a black light, as well as sunlight.

The light including the UV light may be irradiated always or occasionally. Examples of the embodiment include: a use in housing equipment such as a wall, a window, a floor, and a ceiling in a car space and an indoor space to be illuminated occasionally but not illuminated during sleeping or not in a use time; and a use in an outdoor environment exposed to sunlight.

In one embodiment of the coated body according to the present invention, visible light is irradiated to the surface layer. In the coated body of the present invention, the damage ratio of cell membrane of the fungal spores after irradiation of the visible light is less than 10%, and the ATP value after irradiation of the visible light is preferably in the range of more than 0 RLU/cm² to less than 1000 RLU/cm², more preferably in the range of more than 0 RLU/cm² to less than 500 RLU/cm², while the most preferably in the range of more than 0 RLU/cm² to less than 300 RLU/cm².

With this, germination and growth can be suppressed without killing the fungi.

In the coated body of the present invention, the spore's survival ratio after irradiation of the visible light is preferably more than 50%, more preferably more than 70%, while the most preferably more than 90%.

In one embodiment of the coated body according to the present invention, light including UV light is irradiated to the surface layer. In the coated body of the present invention, the damage ratio of cell membrane after irradiation of the light including the UV light is less than 50%, and the ATP value after irradiation of the light including the UV light is preferably in the range of more than 0 RLU/cm² to less than 500 RLU/cm², while more preferably in the range of more than 0 RLU/cm² to less than 300 RLU/cm². The damage ratio of cell membrane after irradiation of the light including the UV light is more preferably less than 30%, while especially preferably less than 10%.

With this, germination and growth can be suppressed without killing the fungi.

In the coated body of the present invention, a survival ratio of the fungal spores attached to the surface after irradiation of the light including UV light is preferably more than 50%, more preferably more than 70%, while the most preferably more than 90%.

Therefore, the function of suppressing fungal growth even inside of a door as well as the excellent function of suppressing fungal growth and/or algal growth outside of a door can be expressed more surely for a long period of time.

In the preferred embodiment of the present invention, the surface layer further includes silica particles.

Therefore, not only the cerium oxide particles can be exposed, but also a strength of the surface layer can be enhanced by binding.

In the preferred embodiment of the present invention, the content of the cerium oxide particles in the surface layer is preferably 1 or more parts by mass, more preferably 10 or more parts by mass, still more preferably 20 or more parts by mass, while the most preferably 40 or more parts by mass, relative to 100 parts by mass of the content of the silica particles.

By containing the cerium oxide particles in such an amount, both the function of the cerium oxide particles and the function of the silica particles can be compatibly satisfied more surely.

In the preferred embodiment of the present invention, the content of the cerium oxide particles in the surface layer is preferably 1 or more parts by mass, more preferably 5% or more parts by mass, while the most preferably 10% or more parts by mass, relative to 100 parts by mass of a total amount of the layer-forming components. In view of the film strength, the upper limit value thereof is preferably 50% by mass, more preferably 40% by mass, while the most preferably 30% by mass.

Therefore, a function of suppressing fungal growth even inside of a door as well as an excellent function of suppressing fungal growth and/or algal growth outside of a door can be expressed more surely for a long period of time.

In the preferred embodiment of the present invention, the surface layer further includes some non-particle components; the content of the non-particle components is less than 10 parts by mass relative to 100 parts by mass of a total amount of the layer-forming components.

The embodiment like this can help for the surface layer to have a porous structure so that fungi and/or algae cannot penetrate through the layer. When the film has the porous structure, the function of the cerium oxide particles can be expressed.

In the preferred embodiment of the present invention, the surface layer has a porous structure, in which the degree of porosity thereof is such that the fungi and/or the algae cannot penetrate through the layer.

The porous structure helps for the cerium oxide particle to express its function, and the non-penetration structure can suppress the fungal growth and/or the algal growth on the contacting face with a substrate as the base of growth.

In the preferred embodiment of the present invention, on the surface of the surface layer, a transparent outermost surface layer containing silica particles is further formed. Here, “transparent” means a property that light can almost reach to the cerium oxide particles that are included in the surface layer.

Therefore, both the function of the cerium oxide particles and the function of the silica particles can be compatibly satisfied more surely.

In view of the function, the coated body of the present invention is characterized by that; the coated body is to suppress fungal growth and/or algal growth after their attaching to the surface thereof; this has a substrate and a surface layer formed on the substrate; a damage ratio of cell membrane of fungal spores after irradiation of visible light is less than 10%, and a ATP value after irradiation of the visible light is preferably in the range of more than 0 RLU/cm² to less than 1000 RLU/cm², more preferably in the range of more than 0 RLU/cm² to less than 500 RLU/cm², while the most preferably in the range of more than 0 RLU/cm² to less than 300 RLU/cm²; and the visible light is irradiated to the surface layer, and the coated body is used under being exposed to an environment in which fungal spores attach to the surface thereof, thereby suppressing fungal growth and/or algal growth after their attaching to the surface of the coated body.

Alternatively, the coated body of the present invention is characterized by that; the coated body is to suppress fungal growth and/or algal growth after their attaching to the surface thereof; this has a substrate and a surface layer formed on the substrate; a damage ratio of cell membrane of fungal spores after irradiation of light including UV light is less than 50%, and an ATP value after irradiation of the light including the UV light is in the range of more than 0 RLU/cm² to less than 500 RLU/cm²; and the light including the UV light is irradiated to the surface layer, and the coated body is used under being exposed to an environment in which fungal spores attach to the surface thereof, thereby suppressing fungal growth and/or algal growth after their attaching to the surface of the coated body.

Definitions and measurement methods of “ATP value”, “damage ratio of cell membrane of fungal spores”, and “spore's survival ratio” in the present invention will be descried below.

ATP Value

In the present invention, the ATP value is to show physiological activity of fungal spores; thus, this is an index to show the degree of the effect of the coated body surface on the fungal spores. The ATP value is obtained by measuring luminescent reaction by using luciferase. The ATP value is defined as follows.

Definition of ATP Value

In the present invention, “ATP value” is defined as luminescence amount that is proportional to a total amount of ATP and AMP with an enzyme cycling method in which luminescent reaction using luciferase is combined with pyruvate orthophosphate dikinase.

ATP Value after Irradiation of Visible Light (Definition)

An inoculum liquid (0.1 mL), obtained by mixing same amounts of a spore suspension with spore's concentration of 1×105/mL (Nothophoma sp.) and 10% Czapek-Dox liquid medium, is smeared onto entire surface of a cleaned coated body (25 mm×25 mm); then, this is dried. Next, visible light is irradiated to the coated body under the environment controlled at 28° C. and a relative humidity of 100%. Then, “ATP value after irradiation of visible light” is defined as the luminescence amount that is proportional to a total amount of ATP and AMP and that is obtained through an enzyme cycling method which uses luminescent reaction using luciferase in combination with pyruvate orthophosphate dikinase In the irradiation of the visible light, visible light with the wavelength of 400 nm or more passed through an UV-cut filter, using white fluorescence lamp as a light source (FLR40SW/M/36-B; manufactured by Hitachi Appliances, Inc.), shall be irradiated at luminosity of 5000 lx (measured with IM-5: illuminometer manufactured by TOPCON TECHNOHOUSE Corp.) for 48 hours.

ATP Value after Irradiation of Light Including UV Light (Definition)

An inoculum liquid (0.1 mL), obtained by mixing same amounts of a spore suspension with spore's concentration of 1×105/mL (Nothophoma sp.) and 10% Czapek-Dox liquid medium, is smeared onto entire surface of a cleaned coated body (25 mm×25 mm); then, this is dried. Next, the visible light is irradiated to the coated body under the environment controlled at 28° C. and a relative humidity of 100%. Then, “ATP value after irradiation of visible light” is defined as the luminescence amount that is proportional to a total amount of ATP and AMP and that is obtained through an enzyme cycling method which uses luminescent reaction using luciferase in combination with pyruvate orthophosphate dikinase. In the irradiation of the light including the UV light, the light with the UV strength of 0.5 mW/cm² (measured with UVR-2: UV strength measurement instrument manufactured by TOPCON TECHNOHOUSE Corp.), using BLB lamp as a light source (FL40SBLB; manufactured by Sankyo Electronics Co., Ltd.), shall be irradiated for 48 hours.

Measurement Method of ATP Value

The ATP value after irradiation of the visible light or the ATP value after irradiation of the light including the UV light is obtained by the measurement method described below. This measurement method is carried out by the processes including preparation of a sample, inoculation of fungal spores, drying, irradiation, and quantification of the ATP value after irradiation.

(Preparation of Sample)

The coated body is going to be an evaluation sample by the process as follows. The coated body is cut to a size of 25 mm×25 mm at fiest, then cleaned by watering or sterilizing, then dried at the end. The sterilization is done preferably by irradiation with a mercury lamp.

(Inoculation of Fungal Spores)

The fungi (Nothophoma sp.) isolated from a field site is pre-cultured in a potato-dextrose agar slant medium at 28° C. for 7 to 14 days; then, spores obtained by pre-culturing are suspended in sterilized and purified water containing 0.005% by weight of Tween 80, which is then followed by dilution with sterilized and purified water in such a way as to give spore's concentration of 1×10⁵/mL to obtain spore suspension. This spore suspension is mixed with the same amount of a 10% Czapek-Dox liquid medium to obtain an inoculum liquid. After 0.1 mL of the inoculum liquid is dropped onto the sample surface, this is smeared to cover the entire surface. The period of pre-culturing is adjusted appropriately such that the ATP value immediately before irradiation may be 100±50 RLU/cm². The processes from preparation of the spore suspension until smearing shall be done within the same day as preparation of the spore suspension.

(Drying)

Next, the coated body smeared with the inoculum liquid is allowed to statically leave in a clean bench at 25° C. for 3 hours for drying. At this time, inside the clean bench is kept in the state of the air therein stirred with a fan. The coated body after dried is allowed to statically leave under an environment controlled at 28° C. and a relative humidity of 100%.

(Irradiation)

Irradiation conditions of the visible light are the same as those described in the definition of the ATP value after irradiation of the visible light mentioned before. Irradiation conditions of the light including the UV light are the same as those described in the definition of the ATP value after irradiation of the light including the UV light mentioned before.

(Quantification of ATP Value)

For quantification of ATP, an ATP wiping test system (manufactured by Kikkoman Corp.) is used. The surface of the coated body is wiped by “Lucipac (registered trade mark) Pen” (manufactured by Kikkoman Corp.), and then, this is inserted into “Lumitester (registered trade mark) PD-30” (manufactured by Kikkoman Corp.) to measure the luminescence amount; then, this amount is converted to the ATP value per unit area of the surface of the coated body.

In the present invention, the function of suppressing fungal growth and/or algal growth can be evaluated by the following indexes (namely, “damage ratio of cell membrane of fungal spores” and “spore's survival ratio”).

Damage Ratio of Cell Membrane of Fungal Spores

In the present invention, the damage ratio of the cell membrane of the fungal spores is defined as follows.

Damage Ratio of Cell Membrane of Fungal Spores (Definition)

In the present invention, the number of spores emitting a green fluorescence by a cell-membrane-permeable nuclear dying reagent and the number of spores emitting a red fluorescence by a cell-membrane-non-permeable nuclear dying reagent are measured; then, the ratio of the number of the spores emitting the red fluorescence relative to the total number of these numbers is defined as the damage ratio of cell membrane of the fungal spores. Here, in the case when the spores in the germination stage and in the mycelial growth stage are present, they are excluded from the measurement object for calculation of the ratio.

Damage Ratio of Cell Membrane of Fungal Spores after Irradiation of Visible Light (Definition)

After the spore suspension (0.1 mL) with spore's concentration of 1×10⁵/mL (Nothophoma sp.) is smeared onto entire surface of a sterilized coated body (25 mm×25 mm) followed by drying, visible light is irradiated to the coated body under the environment controlled at 28° C. and a relative humidity of 100%. The damage ratio of cell membrane after irradiation of the visible light is defined at this stage. In the irradiation of the visible light, the visible light with a wavelength of 400 nm or more passed through an UV-cut filter, using white fluorescence lamp as a light source (FLR40SW/M/36-B; manufactured by Hitachi Appliances, Inc.), shall be irradiated at luminosity of 5000 lx (measured with IM-5: illuminometer manufactured by TOPCON TECHNOHOUSE Corp.) for 48 hours.

Damage Ratio of Cell Membrane of Fungal Spores after Irradiation of Light Including UV Light (Definition)

After the spore suspension (0.1 mL) with spore's concentration of 1×10⁵/mL (Nothophoma sp.) is smeared onto entire surface of a sterilized coated body (25 mm×25 mm) followed by drying, light including UV light is irradiated to the coated body under the environment controlled at 28° C. and a relative humidity of 100%. The damage ratio of cell membrane after irradiation of the light including the UV light is defined at this stage. In the irradiation of the light including the UV light, the light with the UV strength of 0.5 mW/cm² (measured with UVR-2: UV strength measurement instrument manufactured by TOPCON TECHNOHOUSE Corp.), using BLB lamp as a light source (FL40SBLB; manufactured by Sankyo Electronics Co., Ltd.), shall be irradiated for 48 hours.

Measurement Method of Damage Ratio of Cell Membrane of Fungal Spores

The damage ratio of cell membrane of fungal spores after irradiation of the visible light or irradiation of the light including the UV light is obtained by the measurement method described below. This measurement method is carried out by the processes including preparation of a sample, inoculation of fungal spores, drying, irradiation, and quantification of the damage ratio of cell membrane of the fungal spores after irradiation.

(Preparation of Sample)

The sample is prepared in the same way as the sample preparation process used in the measurement of the ATP value as described before.

(Inoculation of Fungal Spores)

The fungi (Nothophoma sp.) isolated from a field site is pre-cultured in a potato-dextrose agar slant medium at 28° C. for 7 to 14 days; then, spores obtained by pre-culturing are suspended in sterilized and purified water including 0.005% by weight of Tween 80, which are then followed by dilution with sterilized and purified water in such a way as to give spore's concentration of 1×10⁵/mL to obtain spore suspension. After 0.1 mL of the spore suspension is dropped onto the sample surface, this is smeared to cover the entire surface.

(Drying)

This is done in the same way as the drying process in the measurement of the ATP value as described before.

(Irradiation)

Irradiation conditions of the visible light are as same as those described in definition of the damage ratio of cell membrane of the fungal spores after irradiation of the visible light, as mentioned before. Irradiation conditions of the light including the UV light are as same as those described in the definition of the damage ratio of cell membrane of the fungal spores after irradiation of the light including the UV light, as described before.

(Quantification of Damage Ratio of Cell Membrane of Fungal Spores)

The quantification procedure is as follows.

(1) The nuclear dying kit (LIVE/DEAD™ FungaLight™ Yeast Viability Kit for flow cytometry; manufactured by Thermo Fisher Scientific Inc.) is used. A fluorescence dying solution in which two types of dying reagents are dissolved is prepared by dissolving SYTO™9 Stain (cell-membrane-permeable nuclear dying reagent; hereinafter, this is described as SYTO9) at a concentration of 15 μM and Propidium Iodide (cell-membrane-non-permeable nuclear dying reagent; hereinafter, this is described as PI) at a concentration of 75 μM in sterilized purified water.

(2) Onto the surface of the coated body, 50 μL of the fluorescence dying solution is dropped. After the sample dropped with the fluorescence dying solution is allowed to statically leave at 25° C. without a light for 30 minutes, the excess fluorescence dying solution is washed out. With irradiating laser beams of 488 nm and 561 nm as the excitation lights, the fluorescence emitted by each of these two nuclear dying reagents is observed by using a confocal fluorescence microscope. SYTO9 emits the fluorescence in the range of 493 nm to 584 nm with a green color. PI emits the fluorescence in the range of 584 nm to 627 nm with a red color.

(3) Of the fungal spores observed with magnification of 340, with excluding those in the stages of germination and mycelial growth, the numbers of the spores emitting the green fluorescence and of the spores emitting the red fluorescence are respectively measured; then, the total number thereof is used as the total spore's number. The spore emitting the red fluorescence is considered “membrane damaged”, and the ratio of the number of the spores with “membrane damaged” to the total spore's number is calculated to obtain the damage ratio of cell membrane.

Spore's Survival Ratio

In the present invention, the spore's survival ratio is defined as follows.

Spore's Survival Ratio (Definition)

The spore suspension (0.1 mL) with spore's concentration of 1×10⁵/mL (Nothophoma sp.) is smeared onto entire surface (25 mm×25 mm) of each of a sterilized coated bodies and, as the reference, a glass plate; then, they are dried. After irradiated under the environment controlled at 28° C. and a relative humidity of 100%, the spores are recovered and then mixed with 10% Czapek-Dox agar medium. After cultured at 28° C. for 7 days, colony forming number is taken as the number of the surviving spores. The ratio of the number of the surviving spores on the surface of the coated body to the number of the surviving spores on the reference is defined as the spore's survival ratio.

Spore's Survival Ratio after Irradiation of Visible Light (Definition)

“Irradiation” in the definition of the spore's survival ratio mentioned above is used as the irradiation condition of the visible light. With this condition, the visible light with a wavelength of 400 nm or more passed through an UV-cut filter, using white fluorescence lamp as a light source (FLR40SW/M/36-B; manufactured by Hitachi Appliances, Inc.), shall be irradiated at luminosity of 5000 lx (measured with IM-5: illuminometer manufactured by TOPCON TECHNOHOUSE Corp.) for 24 hours.

Spore's Survival Ratio after Irradiation of Light Including UV Light (Definition)

“Irradiation” in the definition of the spore's survival ratio mentioned above is used as the irradiation condition of the light including the UV light. With this condition, the light with the UV strength of 0.5 mW/cm² (measured with UVR-2: UV strength measurement instrument manufactured by TOPCON TECHNOHOUSE Corp.), using BLB lamp as a light source (FL40SBLB; manufactured by Sankyo Electronics Co., Ltd.), shall be irradiated for 24 hours.

Measurement Method of Spore's Survival Ratio

The spore's survival ratio after irradiation of the visible light or irradiation of the light including the UV light is obtained by the measurement method described below. This measurement method is carried out by the processes including preparation of a sample, inoculation of fungal spores, drying, irradiation, and quantification of the damage ratio of cell membrane of the fungal spores after irradiation.

(Preparation of Sample)

The sample is prepared in the same way as the sample preparation process used in the measurement of the ATP value as described before. A glass plate is used as the reference; this is treated in the same way as the coated body.

(Inoculation of Fungal Spore)

This is the same as the inoculation process of the fungal spore in the measurement of the damage ratio of cell membrane of the fungal spores as described before. The reference is treated in the same way as the coated body.

(Drying)

This is the same as the drying process in the measurement of the ATP value as described before. The reference is treated in the same way as the coated body.

(Irradiation)

Irradiation conditions of the visible light are the same as those in the definition of the spore's survival ratio after irradiation of the visible light mentioned before. Irradiation conditions of the light including the UV light are the same as those in the definition of the spore's survival ratio after irradiation of the light including the UV light mentioned before.

(Quantification of Spore's Survival Ratio of Fungal Spores)

Quantification procedure is as follows.

The coated body and the reference after irradiated is put in a Stomacher bag together with 4.5 mL of a recovering solution (aqueous solution including 0.005% by weight of sodium dioctyl sulfosuccinate and 0.891% by weight of sodium chloride), which is then followed by ultrasonic irradiation using an ultrasonic cleaning apparatus (V-F100; manufactured by AS ONE Corp.) with output power of 100 W (50 kHz) for 5 minutes to recover the fungi and their spores from the surface of the coated body. Next, this recovered solution including the spores are mixed with 10% Czapek-Dox agar medium. After cultured at 28° C. for 7 days, colony forming number is taken as the number of surviving spores. The ratio of the number of surviving spores on the surface of the coated body to the number of surviving spores on the reference is taken as the spore's survival ratio.

Substrate

The substrate that can be used in the coated body of the present invention can be a metal, an inorganic material, an organic material, and a composite material of them. Specific examples thereof include a tile, a hygienic ceramic, tableware, a calcium silicate plate, an extrusion-molded cement plate, a ceramic substrate, new ceramics such as a semiconductor, an insulator, a glass, a mirror, a wooden material, and a resin. Examples of the substrate expressed as use of parts include an exterior material of a building, an interior material of a building, a window frame, a window glass, a structure member, an exterior of vehicle, an anti-dust cover of an article, a traffic sign board, various display devices, a commercial tower, a sound-seal wall of road, a sound-seal wall of train, a bridge, a guard rail, an interior and paint of a tunnel, an insulator, a cover of a solar cell, a heat-collecting cover of a solar water-heater, a greenhouse, a cover of an illumination lamp for a vehicle, housing equipment, a toilet, a bath, a washstand, a light fixture, an illumination cover, a kitchenware, a dishwasher, a dish dryer, a sink, a cooking range, a kitchen hood, a ventilation fan, and a protection film. These materials include the materials having a film that is formed by printing, painting, covering, lamination, or the like.

Surface Layer

The surface layer of the present invention is the surface layer containing a cerium oxide particles having an oxygen-deficient fluorite structure and having an average crystallite diameter thereof in a range of 10 nm or less; and in a Raman spectrum thereof, a peak attributed to an F_{2g} vibration mode of a Ce—O bond is shifted toward a lower wavenumber by more than 2 cm⁻¹ from a peak attributed to the F_{2g} vibration mode of the Ce—O bond obtained by measurement of a standard substance.

In one embodiment of the coated body according to the present invention, the surface layer formed on the substrate is located on the outermost surface of the coated body.

In one embodiment of the present invention, visible light is irradiated to the surface layer. In the surface layer, the damage ratio of cell membrane of the fungal spores after irradiation of the visible light is less than 10%, and the ATP value after irradiation of the visible light is preferably in the range of more than 0 RLU/cm² to less than 1000 RLU/cm², more preferably in the range of more than 0 RLU/cm² to less than 500 RLU/cm², while the most preferably in the range of more than 0 RLU/cm² to less than 300 RLU/cm².

In one embodiment of the present invention, the spore's survival ratio of the fungal spores attached to the surface layer after irradiation of the visible light is preferably more than 50%.

In another embodiment of the present invention, light including UV light is irradiated to the surface layer. In the surface layer, the damage ratio of cell membrane of the fungal spores after irradiation of the light including the UV light is less than 50%, and the ATP value after irradiation of the light including the UV light is preferably in the range of more than 0 RLU/cm² to less than 500 RLU/cm², while more preferably in the range of more than 0 RLU/cm² to less than 300 RLU/cm². The damage ratio of cell membrane after irradiation of the light including the UV light is more preferably less than 30%, while especially preferably less than 10%.

In another embodiment of the present invention, the spore's survival ratio of the fungal spores attached to the surface layer after irradiation of the light including the UV light is preferably more than 50%.

In view of the function, it is preferable that, in the surface layer of the present invention, the damage ratio of cell membrane of the fungal spores after irradiation of the visible light is less than 10%, and the ATP value after irradiation of the visible light is preferably in the range of more than 0 RLU/cm² to less than 1000 RLU/cm², more preferably in the range of more than 0 RLU/cm² to less than 500 RLU/cm², while the most preferably in the range of more than 0 RLU/cm² to less than 300 RLU/cm²; and the light including the visible light is irradiated to the surface layer, and the surface layer is used under being exposed to an environment in which the fungal spores attach to the surface thereof.

Alternatively, in view of the function, it is preferable that, in the surface layer of the present invention, the damage ratio of cell membrane of the fungal spores after irradiation of the light including the UV light is less than 50%, and the ATP value after irradiation of the light including the UV light is in the range of more than 0 RLU/cm² to less than 500 RLU/cm²; and the light including the visible light is irradiated to the surface layer, and the surface layer is used under being exposed to an environment in which the fungal spores attach to the surface thereof.

The surface layer of the present invention may further include silica particles. In addition, the surface layer may include an arbitrary component not inhibiting the function of the present invention other than the silica particles.

Preferably, the surface layer of the present invention has a porous structure so that the fungi and/or the algae cannot penetrate through the layer.

For this, the matrix component in the surface layer is preferably less than 30% by mass, more preferably less than 10% by mass, while still more preferably 0% by mass.

In order to have the structure of the layer which the fungi and/or the algae cannot penetrate, an average crack width calculated from (crack area)/(crack's circumferential length/2) is preferably less than 3 μm, while more preferably less than 1 μm. The crack area and crack's circumferential length can be measured by an image analysis using a scanning electron microscope.

In the coated body of the present invention, in view of compatibility between suppression of the fungal growth and abrasion resistance, the film thickness of the surface layer is preferably in the range of more than 0.1 μm to less than 5 μm, more preferably in the range of more than 0.3 μm to less than 3 μm, while the most preferably in the range of 0.5 μm to 2 μm. The film thickness can be measured by observation of the cross-sectional view with an electron microscope.

Cerium Oxide Particles

The cerium oxide particles used in the present invention are the cerium oxide particles having an oxygen-deficient fluorite structure and having an average crystallite diameter thereof in a range of 10 nm or less; and in a Raman spectrum thereof, a peak attributed to an F_{2g} vibration mode of a Ce—O bond is shifted toward a lower wavenumber by more than 2 cm⁻¹ from a peak attributed to the F_{2g} vibration mode of the Ce—O bond obtained by measurement of a standard substance.

In the present invention, the cerium oxide having oxygen defects is the cerium oxide having a non-stoichiometric composition expressed by CeO₂₋ₓ(0<x<1).

In the present invention, the average crystallite diameter is calculated by Scherrer equation using an integrated width of the strongest peak (corresponding to the crystal fplane of (111)), that is described in the 2θ peak pattern of the cerium oxide having a fluorite structure (ICDD card No.: 01-078-5328), measured by a X-ray powder diffraction method using the CuKa line as the X-ray source. Here, if the peak is overlapped with the peaks of other blended components, the peak corresponding to the crystal plane of (200) may be used. In measurement of the integrated width, a pattern fitting treatment excluding the background of the X-ray diffraction figure shall be done.

The cerium oxide of the present invention is characterized by that the peak attributed to an F_{2g} vibration mode of a Ce—O bond in a Raman spectrum is shifted toward a lower wavenumber by more than 2 cm⁻¹ from a peak attributed to the F_{2g} vibration mode of the Ce—O bond obtained by measurement of a standard substance. Here, the standard substance of the cerium (IV) oxide with the purity of 99.99% (CEO04PB; manufactured by Kojundo Chemical Laboratory Co., Ltd.) is used. The peak attributed to the F_{2g} vibration mode of the Ce—O bond obtained by measurement of a standard substance appears at about 460 cm⁻¹ with the measurement condition described below. In the present invention, the shift toward a lower wavenumber is defined as the shift from the wavenumber of the detected peak attributed to the F_{2g} vibration mode of the Ce—O bond of the standard substance.

In the present invention, the lower limit of the shift of the peak is preferably 4 or more, while more preferably 6 or more; the upper limit thereof is preferably 10 or less.

The cerium oxide particles are preferably the cerium oxide particles further having a peak attributed to O₂²⁻ (peroxide species) in the Raman spectrum thereof. The peak attributed to O₂²⁻ is reported in J. Phys. Chem. C 2017, 121(38), 20834-20849 and J. Phys. Chem. B 2004, 108, 5341-5348. Specifically, the peak appears in the range of 800 to 900 cm⁻¹.

According to J. Phys. Chem. B 2004, 108, 5341-5348, it is described that the peroxide species, i.e., the adsorbed and activated oxygen like that catalyzes various oxidation reactions. Therefore, in the present invention, it is presumed that this peak would relate to some kind of stress that relates to suppression of germination of the fungal spores.

The measured value of the Raman spectroscopy described above is based on the measurement under the following condition.

Instrument: RAMANTouch (manufactured by Nanophoton Corp.)

Laser wavelength: 532 nm

Wavenumber correction: standard of the F_{2g} vibration mode of Si in a silicon wafer (wavenumber: 520 cm⁻¹) is used.

When the Raman strength goes beyond a proper range depending on a sample, the laser output is adjusted.

In the present invention, in evaluation by Raman spectroscopy, the usable sample is (1) the one that is prepared from crushed powder of the surface layer that is taken out from the coated body or prepared from powder obtained by drying the coating composition, or (2) the coated body.

In preparation of the sample in (1), any one of the following methods is chosen.

The surface layer formed on the substrate surface is washed with ultrapure water followed by drying to obtain the sample. Washing is done until the electric conductivity of the water after washing reaches 10 μS/cm or less.

The surface layer is removed from the coated body; then, after this is crushed with a mortar or the like, the crushed powder is washed with ultrapure water. Washing is done until the electric conductivity of the water after washing reaches 10 μS/cm or less. The crushed powder after washing is dried to obtain the sample.

The coating composition to be described later is dried, and then, this dried product is washed with ultrapure water. Washing is done until the electric conductivity of the water after washing reaches 10 μS/cm or less. The composition after washing is dried to obtain the sample.

In preparation of the sample in (2), any one of the following methods is chosen.

In the case that the coated body contains no component, which has a Raman peak close to the F2g vibration mode of the Ce—O bond around 460 cm−1, under the surface layer, i.e., in the substrate nor, when presents, an intermediate layer between the substrate and the surface layer, which contacts the surface layer, this coated body is washed with ultrapure water and dried; then, this is used as the sample. Washing is done until the electric conductivity of the water after washing reaches 10 μS/cm or less.

A quartz glass plate or a soda lime glass is used as the substrate. This substrate is previously washed; then, the coating composition is applied to this cleaned surface of the substrate to form a surface layer. The coated body formed of the substrate and the surface layer is washed with ultrapure water; then, this is dried to obtain the sample. Washing is done until the electric conductivity of the water after washing reaches 10 μS/cm or less.

The content of the cerium oxide particles in the surface layer is preferably 1 or more parts by mass, more preferably 5 or more parts by mass, while the most preferably 10% or more by mass.

Silica Particles

The surface layer may further include silica particles. Therefore, not only the cerium oxide particles can be exposed, but also the strength of the surface layer can be enhanced by binding.

From a viewpoint to suppress fungal growth and algal growth by the cerium oxide particles, the content of the cerium oxide particles in the surface layer is preferably more than 1 parts by mass, more preferably 5 parts by mass, still more preferably 10 parts by mass, far still more preferably more than 20 parts by mass, while the most preferably more than 40 parts by mass, relative to 100 parts by mass of the content of the silica particles.

From a viewpoint to keep hydrophilicity, when the surface layer of the coated body includes the silica particles, the content of the cerium oxide particles is preferably less than 120 parts by mass, more preferably less than 80 parts by mass, while the most preferably less than 100 parts by mass, relative to 100 parts by mass of the silica particle content.

The amount of the silica particles in the surface layer of the coated body is preferably 30% or more by mass, more preferably 50% or more by mass, while the most preferably 70% or more by mass. With this, hydrophilicity and the abrasion resistance of the surface layer are enhanced.

The silica particles are included in the surface layer of the coated body with the amount of preferably less than 90% by mass. With this, the function of the cerium oxide can be compatibly satisfied with the hydrophilicity as well as the abrasion resistance of the surface layer.

The average particle diameter of the silica particles is preferably less than 100 nm, more preferably less than 50 nm, while still more preferably less than 30 nm. With this, the abrasion resistance of the surface layer can be enhanced.

The average particle diameter of the silica particles is calculated as the number average of the lengths of arbitrary 100 particles present in a view field of a scanning electron microscope with magnification of 200,000. The shape of the particle is the most preferably a true sphere, but this may be a rough circle or an oval shape; in these later cases the length of the particle is roughly calculated from ((long diameter+short diameter)/2).

Arbitrary Component

The surface layer may include, as an arbitrary component, a non-particle component and an oxide particles other than the cerium oxide particles and the silica particles.

Examples of the usable oxide particles other than the cerium oxide particles and the silica particles include particles of monooxides such as alumina, zirconia, boronia, and silicate salts, as well as particles of composite oxides such as boron silicate salts, aluminosilicate salts, and barium titanate.

(Non-Particle Component)

Examples of the usable non-particle component include a matrix component.

Examples of the usable matrix component include an organic resin, an organic inorganic composite resin, and an organic or inorganic polymer.

Examples of the usable organic resin include compounds such as an acryl resin, a urethane resin, and an acryl urethane resin.

Examples of the organic inorganic composite resin include a composite body of a silicon compound with a compound that constitutes the organic resin mentioned above. Preferably, the usable organic inorganic composite resin is a composite body of silicone with the organic resin, specifically a silicone resin and a silicone-modified resin.

Examples of the usable organic polymer include polyoxyalkylenes such as polyethylene oxide, polypropylene oxide, and block polymers of them.

Examples of the usable inorganic polymer include: monooxides of metals such as silicon, titanium, zirconium, and tin; composite oxides of these metals; and composite oxides of these metals with sodium, potassium, or lithium. Preferably, these compounds are formed at the time of forming the surface layer by using precursor compounds that are soluble in a dispersing medium (this will be described later).

Outermost Surface Layer

The coated body of the present invention may further form an outermost layer on the surface layer. When the outermost layer has a light-transmitting property, visible light or light including UV light can be irradiated to the cerium oxide included in the surface layer. The thickness of the outermost layer is preferably 1 μm or less, 0.5 μm or less, or 0.1 μm or less. Therefore, hydrophilicity of the surface can be enhanced more surely, so that a self-cleaning property can be enhanced. In addition, preferably the outermost layer is substance-permeable, while more preferably the outermost layer is porous. In the preferred embodiment, the outermost layer is a porous layer including the silica particle or a porous layer formed of the silica particle.

Formation Method of the Coated body

In the coated body of the present invention, the surface layer is formed on the substrate. The surface layer may be formed by any of a dry filming method and a wet filming method.

The dry filming method may be carried out by using a so-called “Aerosol Deposition” method, in which a powder including PVD, CVD, or the cerium oxide particle is collided to a substrate under an environment of a reduced pressure thereby depositing the cerium oxide particle. Alternatively, the cerium oxide of the present invention can be prepared by post-treatment of the film that is formed by any of these methods.

In this post-treatment, any one or more selected from a heat-treatment in an atmosphere of an inert gas or a reductive gas (for example, hydrogen, nitrogen, carbon monoxide, and argon), a heat-treatment under vacuum, a mechanochemical treatment (cerium oxide of the present invention is prepared by applying a stress such as a pressure or a sliding force to the surface layer), a discharge treatment, a plasma treatment, and an acid/alkali treatment.

The wet filming method may be carried out by the method that includes the process in which the coating composition to be described later is applied to a substrate surface.

Preferably, the coating composition may be applied to a substrate by spraying, roll-coating, die-coating, or flow-coating. The application may be carried out manually or mechanically.

The wet filming method by application may be carried out in a production line of a factory or on site. Drying and heating conditions after application are not particularly restricted so far as the functions of the cerium oxide particles are not impaired; for example, the temperature condition of a normal temperature to about 500° C. may be suitably used. The pre-treatment before application such as a pre-heating treatment, a discharge treatment, a plasma treatment, and an acid/alkali treatment of the substrate as well as the post-treatment such as a discharge treatment, a plasma treatment, and an acid/alkali treatment may be additionally carried out.

Use of the Coated Body

The coated body of the present invention may be widely used as an indoor material and an outdoor material in the place where suppression of fungal growth or algal growth is necessary.

Examples of the interior member suitably usable include: water-related equipment such as a hygienic ceramic, a washbowl, a toilet mirror, a unit bath, a bath mirror, a kitchen, a kitchen sink, a bath wall, a bath floor, a bath ceiling, and local cleaning equipment; kitchenware such as an oven, a range, a kitchen hood, a ventilation fan, a cutting plate, tableware, a refrigerator, a dish washer, and a dish dryer; building interior materials such as an interior tile, a door, an interior paper, a window glass, a window sash, storage furniture, a housing storage construction material, a ceiling, a floor, and a wall; housing equipment such as a bedding, a chair, a table, illumination equipment, and air-conditioning equipment; vehicle equipment; and a film to be fixed to the surface of them.

Examples of the outdoor member suitably usable include: a building exterior material, an outdoor wall, a roof, roof equipment, a solar cell cover, a heat-collecting cover of a solar water-heater, a green house, a window glass, a window sash, and a film to be fixed to the surface of them.

Coating Composition

A coating composition to be provided by one aspect of the present invention can form a coated body on a substrate by coating. Therefore, by merely coating on the substrate, the coating composition of the present invention can express a function of suppressing fungal growth even inside of a door as well as an excellent function for suppressing fungal growth and/or algal growth outside of a door for a long period of time.

In the embodiment of the coating composition, the embodiments described below are also preferable for the same reason as the embodiments of the coated body explained above.

Therefore, one inventive embodiment of the coating composition of the present invention is characterized by that: the coating composition includes cerium oxide particles having an oxygen-deficient fluorite structure and having an average crystallite diameter thereof in a range of 10 nm or less; in a Raman spectrum of the cerium oxide particle, a peak attributed to an F_{2g} vibration mode of a Ce—O bond is shifted toward a lower wavenumber by more than 2 cm¹ from a peak attributed to the F_{2g} vibration mode of the Ce—O bond obtained by measurement of a standard substance; and a coated body provided with a surface layer in which a substrate thereof is coated with the coating composition can suppress fungal growth and/or algal growth after their attaching to a surface of this coated body.

Here, the average crystallite diameter is calculated by Scherrer equation using an integrated width of the strongest peak (corresponding to the crystal plane of (111)) that is described in the 2θ peak pattern of the cerium oxide having a fluorite structure (ICDD card No.: 01-078-5328) measured by a X-ray powder diffraction method using the CuKa line as the X-ray source. Here, if the peak is overlapped with the peaks of other blended components, the peak corresponding to the crystal plane of (200) may be used. In measurement of the integrated width, a pattern fitting treatment excluding the background of the X-ray diffraction figure shall be done.

In the present invention, evaluation of the oxygen defects in the cerium oxide particles is done by Raman spectroscopy. The cerium oxide of the present invention is characterized by that the peak attributed to an F_{2g} vibration mode of a Ce—O bond in a Raman spectrum is shifted toward a lower wavenumber by more than 2 cm⁻¹ from a peak attributed to the F_{2g} vibration mode of the Ce—O bond obtained by measurement of a standard substance. Here, the standard substance of the cerium (IV) oxide with the purity of 99.99% (CEO04PB; manufactured by Kojundo Chemical Laboratory Co., Ltd.) is used. The peak attributed to the F_{2g} vibration mode of the Ce—O bond obtained by measurement of the standard substance appears at about 460 cm⁻¹ with the measurement condition described below. In the present invention, the shift toward a lower wavenumber is defined as the shift from the wavenumber of the detected peak attributed to the F_{2g} vibration mode of the Ce—O bond of the standard substance.

In the present invention, the lower limit of the shift of the peak is preferably 4 or more, while more preferably 6 or more; the upper limit thereof is preferably 10 or less.

The cerium oxide particles are preferably the cerium oxide particles further having a peak attributed to O₂²⁻ (peroxide species) in the Raman spectrum thereof. The peak attributed to O₂²⁻ is reported in J. Phys. Chem. C 2017, 121(38), 20834-20849 and J. Phys. Chem. B 2004, 108, 5341-5348. Specifically, the peak appears in the range of 800 to 900 cm⁻¹.

According to J. Phys. Chem. B 2004, 108, 5341-5348, it is described that the peroxide species, i.e., the adsorbed and activated oxygen like that catalyzes various oxidation reactions. Therefore, it is presumed that this peak is the peak relating to the suppression of the fungal growth based on the present invention.

The measured value of the Raman spectroscopy described above is based on the measurement under the following condition.

Instrument: RAMANTouch (manufactured by Nanophoton Corp.)

Laser wavelength: 532 nm

Wavenumber correction: standard of the F_{2g} vibration mode of Si in a silicon wafer (wavenumber: 520 cm⁻¹) is used

When the Raman strength goes beyond a proper range depending on a sample, the laser output is adjusted.

The sample for the Raman spectroscopic measurement is prepared by the procedure described below.

In the present invention, in evaluation by Raman spectroscopy, the usable sample is (1) the one that is prepared from a crushed powder of the surface layer that is removed from the coated body or prepared from a powder obtained by drying the coating composition, or (2) the coated body.

In preparation of the sample in (1), any one of the following methods is chosen.

The surface layer formed on the substrate surface is washed with ultrapure water followed by drying to obtain the sample. Washing is done until the electric conductivity of the water after washing reaches 10 μS/cm or less.

The surface layer is removed from the coated body; then, after this is crushed with a mortar or the like, the crushed powder is washed with ultrapure water. Washing is done until the electric conductivity of the water after washing reaches 10 μS/cm or less. The crushed powder after washing is dried to obtain the sample.

The coating composition to be described later is dried, and then, the dried product is washed with ultrapure water. Washing is done until the electric conductivity of the water after washing reaches 10 μS/cm or less. The composition after washing is dried to obtain the sample.

In preparation of the sample in (2), any one of the following methods is chosen.

In the case when the coated body not having a component, which has a Raman peak close to the F_{2g} vibration mode of the Ce—O bond around 460 cm⁻¹, in the substrate side from the substrate side surface of the surface layer, namely, in an intermediate layer that is present in the substrate or between the substrate and the surface layer and that contacts with the surface layer, or in the substrate that contacts with the surface layer, this is washed with ultrapure water and dried; then, this is used as the sample as it is. Washing is done until the electric conductivity of the water after washing reaches 10 μS/cm or less.

A quartz glass plate or a soda lime glass plate is used as the substrate. This substrate is previously washed; then, the coating composition is applied to this cleaned surface of the substrate to form a surface layer. The coated body formed of the substrate and the surface layer is washed with ultrapure water; then, this is dried to obtain the sample. Washing is done until the electric conductivity of the water after washing reaches 10 μS/cm or less.

The content of the cerium oxide particle in the coating composition is preferably 1 or more parts by mass, more preferably 5 or more parts by mass, while the most preferably 10% or more by mass, relative to 100 parts by mass of a total amount of the layer-forming components in the coating composition.

Here, the layer-forming components are the components to constitute the surface layer of the present invention. They are, as the essential component, the cerium oxide particles, and, as arbitrary component, the silica particles, metal oxide particles other than the cerium oxide particles and the silica particles, and a non-particle component. When precursors of these components are present in the coating composition, the products after application of the composition are the layer-forming components.

When an organic component is not included in the particle component and the non-particle component, a dispersing medium included in the coating composition and some additive agents that are non-reactive and soluble in a dispersing medium (additive agents such as a surfactant, a thickener, and a solvent having a high-boiling point) do not belong to the layer-forming components. In this case, quantity of the layer-forming components is obtained from the constant weight of the ignition residue after heating of the coating composition at 400° C.

When an organic component is included in the particle component and the non-particle component, quantity of the layer-forming components is obtained from the constant weight after heating of the coating composition at 110° C.

The content of the layer-forming components in the coating composition is preferably in the range of 0.1% to 80% by mass.

The coating composition may further include silica particles. Therefore, not only the cerium oxide particles can be exposed, but also the strength of the surface layer can be enhanced by binding.

The content of the cerium oxide particles in the coating composition is preferably more than 1 parts by mass, more preferably 5 parts by mass, still more preferably 10 parts by mass, far still more preferably more than 20 parts by mass, while the most preferably more than 40 parts by mass, relative to 100 parts by mass of the content of the silica particles.

From a viewpoint to keep hydrophilicity, when the coating composition includes the silica particles, the content of the cerium oxide particles is preferably less than 120 parts by mass, more preferably less than 80 parts by mass, while the most preferably less than 100 parts by mass, relative to 100 parts by mass of the silica particle content.

The amount of the silica particles is preferably 30% or more by mass, more preferably 50% or more by mass, while the most preferably 70% or more by mass, relative to 100% by mass of the total amount of the layer-forming components in the coating composition. With this, hydrophilicity and the abrasion resistance are enhanced.

The silica particles are included with the amount of preferably less than 90% by mass relative to 100% by mass of a total amount of the layer-forming components in the coating composition. With this, the function of the cerium oxide can be compatibly satisfied with the hydrophilicity as well as the abrasion resistance of the surface layer.

The average particle diameter of the silica particles is preferably less than 100 nm, more preferably less than 50 nm, while still more preferably less than 30 nm. With this, the abrasion resistance of the surface layer can be enhanced.

The average particle diameter of the silica particles is calculated as the number average of the lengths of arbitrary 100 particles present in a view field of a scanning electron microscope with magnification of 200,000. The shape of the particle is the most preferably a true sphere, but this may be a rough circle or an oval shape; in these later cases the length of the particle is roughly calculated from ((long diameter+short diameter)/2).

The coating composition is used in the form of the coated body which is formed by coating the composition on the substrate so as to suppress the fungal growth and/or the algal growth on the surface of the coated body.

There are a dry filming method and a wet filming method in the coating method onto the substrate.

The coating composition to be used in the dry filming method is formed of a powder body including the cerium oxide particles.

The powder body with an intended composition including the cerium oxide particles is prepared by using an attritor, a beads mill, or the like to obtain the coating composition.

The coating composition is made to include a dispersing medium to obtain the coating composition to be used in the wet filming method.

The coating composition can be produced by dispersing into a dispersing medium the cerium oxide particles, as well as other solid components and precursors thereof that are added as needed. In the on-site coating, this method is more convenient.

The coating composition may include, as an arbitrary component, at least one kind selected from non-particle components, additive agents, and metal oxide particles other than the cerium oxide particles and the silica particles.

Examples of the usable oxide particles other than the cerium oxide particles and the silica particles include particles of monooxides such as alumina, zirconia, boronia, and silicate salt, as well as particle of composite oxides such as boron silicate salts, aluminosilicate salts, and barium titanate.

In the preferred embodiment of the present invention, the content of the non-particle components is less than 10 parts by mass relative to 100 parts by mass of a total solid components in the coating composition.

The embodiment like this can help, upon forming the film on the substrate, to have the structure of the layer which the fungi and/or the algae cannot penetrate. The porous structure of the film helps for the cerium oxide particles to express its function, and the non-penetration structure can suppress the fungal growth and/or the algal growth on the contacting face with a substrate as the base of growth.

Examples of the usable non-particle component include a matrix component.

Examples of the usable matrix component include an organic resin, an organic inorganic composite resin, an organic or inorganic polymer, and an organometallic polymer.

Examples of the usable organic resin include compounds such as an acryl resin, a urethane resin, and an acryl urethane resin, in the form of or as the dispersed body of them. Alternatively, precursors capable of forming these resins, such as a monomer having an unsaturated double bond, an isocyanate compound, an amine, or an oligomer thereof may be used as well.

Examples of the organic inorganic composite resin include a composite body of a silicon compound with a compound that constitutes the organic resin mentioned above. Preferably, the usable organic inorganic composite resin is a complex body of silicone with the organic resin; specific examples thereof include a silicone resin and a silicone-modified resin, in the form of or as the dispersed body of them. Alternatively, the precursors capable of forming the silicone as well as the precursors capable of forming the organic resin may be used as well.

Examples of the usable organic polymer include polyoxyalkylenes such as polyethylene oxide, polypropylene oxide, and block polymers of them.

Examples of the usable inorganic polymer include: monooxides of metals such as silicon, titanium, zirconium, and tin; composite oxides of these metals; and precursors capable of forming composite oxides of these metals with sodium, potassium, or lithium. The usable precursors are a metal salt, a metal halide compound, a metal alkoxide, a hydrolysate of them, and a metal peroxide.

Examples of the usable additive agent include a heretofore known leveling agent, an anti-foaming agent, a dispersant, and a pH-controlling agent.

In the preferred embodiment of the present invention, the coating composition further includes a dispersing medium. This can help to uniformly form a film on the substrate. Hardly water-solble and/or water-insoluble solvents may be suitably used. Heretofore known organic solvents may be used as the water-insoluble solvent; water-soluble solvents such as an alcohol, as well as the solvents that are hardly soluble or insoluble in water can be suitably used as well.

Use of the Coating Composition

In one embodiment of the coating composition, after the coated body having the surface layer coated on the substrate is formed, this is used in the embodiment in which the fungal growth and/or the algal growth after their attaching to the surface of the coated body is suppressed with irradiating visible light to the surface layer.

In another embodiment of the coating composition, after the coated body having the surface layer coated on the substrate is formed, it is also a preferable embodiment that the fungal growth and/or the algal growth after their attaching to the surface of the coated body is suppressed with irradiating light including UV light to the surface layer.

Method for Suppressing Fungal Growth

Provided by the present invention is a method to suppress fungal growth, in which a substance capable of suppressing metabolism of a fungal spore without damaging a cell membrane of the fungal spores is caused to act on the spore. According to this method, a function to suppress the fungal growth can be expressed for a long period of time.

In the invention described above, although the reason for realization of the above-mentioned effect is not clear yet, it seems to be as follows. However, the following explanation is only a hypothesis; so the present invention is not restricted at all by the hypothesis described below.

The reason for this is presumably as follows. Namely, in a general antifungal method, the cell membrane of fungal spores is damaged or the fungal spore is killed. Therefore, the protein in the fungi is oozed out from the cell tissue; and this protein is remained and accumulated in the state of being oozed out. This becomes the base and nutrition source of the fungal spore that is newly attached from outside thereby leading to gradual increase in the accumulated layer including fungi and bacteria, and this in turn resulting in formation of the portion to which light cannot reach readily. So, especially inside of a door or the like, the effect is gradually decreased on a long-term basis. According to the present invention, on the other hand, because the cell membrane of the fungal spores is not damaged, the drawback of the general antifungal agent can be overcome, and at the same time, germination and growth can be suppressed.

Provided by the present invention is a method to suppress the algal growth by suppressing the fungal growth, in which a substance capable of suppressing metabolism of a fungal spore without damaging a cell membrane of the fungal spores is caused to act on the spore. According to this method, an excellent function to suppress the algal growth outside of a door can be expressed for a long period of time.

The inventor of the present invention studied algal attachment mechanism outside of a door by observation; as a result, it was found that the algae grew by attaching to mycelia that were extended and branched after germination of the fungal spores. Accordingly, if the fungal growth can be effectively suppressed for a long period of time, the algal growth on the coated surface outside of a door can be suppressed as well.

In the suppressing method of the fungal growth and the algal growth mentioned above, the ATP value after irradiation of the visible light, which represents suppression of metabolism of the spores, is preferably in the range of more than 0 RLU/cm² to less than 1000 RLU/cm², more preferably in the range of more than 0 RLU/cm² to less than 500 RLU/cm², while the most preferably in the range of more than 0 RLU/cm² to less than 300 RLU/cm².

In the suppressing method of the fungal growth and the algal growth mentioned above, the ATP value after irradiation of the light including the UV light, which represents suppression of metabolism of the spores, is preferably in the range of more than 0 RLU/cm² to less than 500 RLU/cm², while more preferably in the range of more than 0 RLU/cm² to less than 300 RLU/cm².

Therefore, germination and growth can be effectively suppressed.

Provided by the present invention is a coated body to suppress growth of fungi and/or algae attached to a surface thereof, characterized by that; this has a substrate and a surface layer formed on the substrate; on a surface thereof, a damage ratio of cell membrane of fungal spores after irradiation of the visible light is less than 10%, and an ATP value after irradiation of the visible light is preferably in the range of more than 0 RLU/cm² to less than 1000 RLU/cm², more preferably in the range of more than 0 RLU/cm² to less than 500 RLU/cm², while the most preferably in the range of more than 0 RLU/cm² to less than 300 RLU/cm²; the visible light is irradiated to the surface layer, and the coated body is used under being exposed to an environment in which fungal spores attach to a surface thereof; and growth of the fungi and/or the algae attached to a surface of the coated body is suppressed.

Therefore, the function of suppressing the fungal growth even inside of a door as well as an excellent function for suppressing the fungal growth and/or the algal growth outside of a door can be expressed for a long period of time.

The reason for this is presumably as follows. Namely, in a general antifungal method, the cell membrane of fungal spores is damaged or the fungal spore is killed. Therefore, the protein in the fungi is oozed out from the cell tissue; and this protein is remained and accumulated in the state of being oozed out. This becomes the base and nutrition source of the fungal spore that is newly attached from outside thereby leading to gradual increase in the accumulated layer including fungi and bacteria, and this in turn leading to formation of the portion to which light cannot reach readily. So, especially inside of a door or the like, the effect is gradually decreased on a long-term basis. According to the present invention, on the other hand, because the cell membrane of the fungal spores is not damaged, the drawback of the general antifungal agent can be overcome, and at the same time, germination and growth can be suppressed.

Provided by the present invention is a coated body to suppress growth of fungi and/or algae attached to a surface thereof, characterized by that; this has a substrate and a surface layer formed on the substrate; on a surface thereof, a damage ratio of cell membrane of fungal spores after irradiation of light including UV light is less than 50%, and an ATP value after irradiation of the light including the UV light is in the range of more than 0 RLU/cm² to less than 500 RLU/cm²; the light including the UV light is irradiated to the surface layer, and the coated body is used under being exposed to an environment in which fungal spores attach to a surface thereof; and growth of the fungi and/or the algae attached to a surface of the coated body is suppressed.

Therefore, the function of suppressing fungal growth even inside of a door as well as an excellent function for suppressing the fungal growth and/or the algal growth outside of a door can be expressed for a long period of time.

The reason for this is presumably as follows. Namely, in a general antifungal method, the cell membrane of fungal spores is damaged or the fungal spore is killed. Therefore, the protein in the fungi is oozed out from the cell tissue; and this protein is remained and accumulated in the state of being oozed out. This becomes the base and nutrition source of the fungal spores that is newly attached from outside thereby leading to gradual increase in the accumulated layer including fungi and bacteria, and this in turn leading to formation of the portion to which light cannot reach readily. So, especially inside of a door or the like, the effect is gradually decreased on a long-term basis. On the other hand, because the cell membrane of the fungal spores is not damaged, the drawback of the general antifungal agent can be overcome, and at the same time, germination and growth can be suppressed.

Suppressing Method of Biological Fouling

In the method for suppressing the fungal growth according to the present invention, a substance that can suppress metabolism of a fungal spore without damaging cell membrane of the spores is caused to act on the fungi.

In the method for suppressing the algal growth according to the present invention, a substance that can suppress metabolism of fungal spores without damaging cell membrane of the spores is caused to act on the fungi thereby suppressing the fungal growth.

For suppression of metabolism of the spores, the ATP value after irradiation of the visible light is preferably in the range of more than 0 RLU/cm² to less than 1000 RLU/cm².

For suppression of metabolism of the spores, the ATP value after irradiation of the light including the UV light is preferably in the range of more than 0 RLU/cm² to less than 500 RLU/cm².

Here, as the substance that can suppress metabolism of a fungal spores without damaging cell membrane of the spores, the cerium oxide mentioned above or the substance that has the same action mechanism as the cerium oxide is preferably used.

In the method described above, preferably, the substance that can suppress metabolism of a fungal spores without damaging cell membrane of the spores is caused to act on fungi or algae, and at the same time, the visible light or the light including the UV light is caused to act on the fungi or the algae.

Therefore, growth of the fungi and/or the algae attached to the surface can be suppressed more effectively.

### EXAMPLES

The present invention will be further explained by following Examples, but the present invention is not limited to these Examples.

Materials

### Substrates

a A soda lime glass plate

b A quartz glass plate

c The substrate c was obtained in the way as follows: a primer mainly containing an epoxy resin was applied to an aluminum substrate, and then, this was dried at normal temperature for 24 hours. Then, onto this was further applied an enamel paint containing a silicone-modified acryl resin and a white pigment, and then, this was dried at normal temperature for 24 hours.

Cerium Oxide Particle

1-1 Cerium oxide sol (fluorite-type, basic, cerium oxide concentration: 10% by weight, average crystallite diameter: 6 nm)

1-2 Cerium oxide sol (fluorite-type, basic, cerium oxide concentration: 10% by weight, average crystallite diameter: 8 nm)

1-3 Cerium oxide sol (fluorite-type, basic, cerium oxide concentration: 10% by weight, average crystallite diameter: 10 nm)

1-4 Cerium oxide powder (fluorite-type, average crystallite diameter: 78 nm)

Silica Particle

2-1 Water-dispersed colloidal silica (Na dispersion, SiO₂ concentration: 30% by weight, average particle diameter: 25 nm) Titanium Oxide Particle

3-1 Titanium oxide water-dispersed body (anatase type, basic, TiO₂ concentration: 17.5% by weight, average particle diameter: 45 nm)

Dispersing Medium: purified water

Additive: polyether-modified silicone-type surfactant

Preparation of the Coating Composition

(1) The cerium oxide sol or the cerium oxide powder, (2) the water-dispersed colloidal silica, (3) the titanium oxide water-dispersed body, (4) the dispersing medium, and (5) the additive were mixed so as to give the composition shown in Table 1, so that the coating composition was obtained. The concentration of the layer-forming components in the coating composition was made to 5.5% by mass. Here, the concentration of the layer-forming components is the concentration of a total amount of (1) to (3) (charged amount) in the coating composition. For reference, after the coating composition was heated to 400° C., this was gradually cooled to room temperature; then, the constant weight was measured. The concentration of the constant weight agreed with the concentration of the layer-forming components.

TABLE 1

| | | | | Titanium | |
|---|---|---|---|---|---|
| | | | | oxide | Silica |
| | | Cerium oxide particle | | particle | particle |
| Coating | | | [parts by | [parts by | [parts by |
| composition | | Kind | mass] | mass] | mass] |
| C1 | Example | 1-1 | 100 | 0 | 0 |
| C2 | Example | 1-2 | 100 | 0 | 0 |
| C3 | Comparative | 1-3 | 100 | 0 | 0 |
| | Example | | | | |
| C4 | Comparative | 1-4 | 100 | 0 | 0 |
| | Example | | | | |
| C5 | Example | 1-1 | 10 | 0 | 90 |
| C6 | Example | 1-1 | 50 | 0 | 50 |
| C7 | Comparative | — | 0 | 10 | 90 |
| | Example | | | | |
| C8 | Comparative | — | 0 | 0 | 100 |
| | Example | | | | |

Test 1: Evaluation of Physical Properties of Cerium Oxide

### Sample Preparation

The coating compositions C1 to C4 were used. Each of the coating compositions was freeze-dried. The freeze-dried product thus obtained was added with ultrapure water, which was then followed by stirring, removal of water, and again freeze-drying to obtain the cleaned dry product. The washing procedure was repeated until the conductivity of the washing water reached less than 10 μS/cm. With regard to the cleaned product originated from C1, products obtained by further heating this cleaned product in an air at 200° C., 400° C., 600° C., and 850° C., respectively, for 1 hour were also prepared. These heat-treated products and the product without heat-treatment were used as the samples for Raman spectroscopic measurement. The combinations of the coating compositions with the heating temperatures are shown in Table 2.

TABLE 2

| | Coating | Heating temp. |
|---|---|---|
| Sample No. | composition | [° C.] |
| 1 | C1 | No (room temp.) |
| 2 | C1 | 200 |
| 3 | C1 | 400 |
| 4 | C1 | 600 |
| 5 | C1 | 850 |
| 6 | C2 | No (room temp.) |
| 7 | C3 | No (room temp.) |
| 8 | C4 | No (room temp.) |

Test 1(1): Raman Spectroscopic Measurement

The sample described in Table 2 was filled in a sample holder so as to give the thickness of 1 mm for the Raman spectroscopic measurement. The measurement conditions were as follows.

Instrument: RAMANTouch (manufactured by Nanophoton Corp.)

Laser wavelength: 532 nm

Laser output: 1×10⁵ W/cm²

Pin-hole size: 50 μm

Diffraction grating: 600 gr/mm

Measured wavenumber: 100 to 2600 cm⁻¹ (with setting the central wavenumber at 1500 cm⁻¹, the measurement was done in this range of the measurement wavenumber)

Irradiation time: 10 seconds

Accumulation number: once

Objective lens: TU Plan Fluorx10 (NA: 0.30)

The shift toward a lower wavenumber was calculated as the difference between the wavenumber of the detected peak attributed to the F_{2g} vibration mode of the Ce—O bond thereof obtained by measurement of a standard substance (cerium oxide manufactured by Kojundo Chemical Laboratory Co., Ltd.; catalogue No.: CEO04PB, Lot No.: 4702411) and the wavenumber of the peak attributed to the same mode obtained by measurement of the sample.

That the adsorbed oxygen was activated as a peroxide species was confirmed by the peak that appeared in the range of 800 to 900 cm⁻¹.

The results are summarized in Table 3.

TABLE 3

Raman spectroscopic measurement result

| | Shift of F_{2 g}/Ce—O | Activated oxygen |
|---|---|---|
| | peak to lower | adsorbed on CeO₂: |
| Sample No. | wavenumber(cm⁻¹) | O₂²⁻peak |
| 1 | 8.6 | Yes |
| 2 | 8.6 | Yes |
| 3 | 4.3 | No |
| 4 | 0 | No |
| 5 | 0 | No |
| 6 | 2.2 | No |
| 7 | 0 | No |
| 8 | 0 | No |

Among those having a large shift of the peak attributed to the F_{2g} vibration mode of the Ce—O bond toward a lower wavenumber, in the sample No. 1 to 3, Raman scattering indicating the adsorbed, activated oxygen was confirmed in the wavenumber range of 800 to 900 cm⁻¹. So, it is presumed that this species applies some kind of strong stress to the fungal spores.

Test 1(2): Optical Characteristics

With regard to the optical characteristics of the samples described in Table 2, the diffusion reflectance spectra of them were measured by using a UV-visible spectrophotometer (manufactured by JASCO Corp.) with an integrating sphere unit belonging to this instrument. Namely, for the measurement, the sample powder was filled in the attached PSH-002 type powder sample cell. The diffusion reflectance spectrum is expressed by the wavelength in the horizontal axis and the reflectance in the vertical axis. The instrument and the measurement conditions used for evaluation were as follows.

Instrument: V-670 type UV-visible spectrophotometer with the ISN-723 type integrating sphere unit (manufactured by JASCO Corp.)

Photometry mode: % R

Measurement range: 1000 to 200 nm

Data in-take interval: 1 nm

UV/Vis band width: 1 nm

NIR band width: 8 nm

Response: fast

Scanning speed: 200 nm/minute

Change of light source: 340 nm

Light source: heavy hydrogen lamp (short wavelength side)/halogen lamp (long wavelength side)

Change of diffraction grating/detector: 850 nm

From the reflectance of the obtained diffusion reflectance spectrum, the absorption rates in the wavelengths at 600 nm and 800 nm were calculated by the equation 1.

A=100−R Equation 1

R: actually measured reflectance (%)

A: absorption rate (%)

Evaluation was done by whether or not the visible light absorption gradually attenuated toward a long wavelength in the wavelength region of more than 500 nm could be seen. Specifically, the ratio of the absorption rate at 600 nm to the absorption rate at 800 nm was calculated by equation 2. When the ratio was more than 1.2, this was judged “Yes”.

Ratio of absorption rates=A600/A800 Equation 2

A600: absorption rate (%) at 600 nm calculated from equation 1

A800: absorption rate (%) at 800 nm calculated from equation 1

The diffusion reflectance spectrum thus obtained was transformed by Kubelka-Munk to obtain a Kubelka-Munk function from the reflectance in the vertical axis. Further, cerium oxide was considered as an indirect allowed transition type semiconductor. By the Tauc plot, the Kubelka-Munk function in the vertical axis was raised to the power of ½. Also, the wavelength in the horizontal axis is transformed to an energy by E=hv. From these transformation results, the band gap energy and optical absorption edge wavelength of cerium oxide were calculated according to the usual way. This calculation method was determined by referring to Japanese Patent No. 5949567. The results are described in Table 4.

TABLE 4

Optical absorption characteristics

| | Optical | Band gap | Optical absorption |
|---|---|---|---|
| | absorption | energy | edge wavelength |
| Sample No. | λ > 500 nm | (eV) | (nm) |
| 1 | Yes | 2.5 | 495 |
| 2 | Yes | 2.5 | 494 |
| 3 | No | 2.5 | 489 |
| 4 | No | 2.6 | 481 |
| 5 | No | 2.5 | 490 |
| 6 | No | 2.8 | 489 |
| 7 | No | 2.7 | 468 |
| 8 | No | 2.9 | 424 |

It was confirmed that all of the cerium oxides had optical absorption due to the interband transition in the visible light region of less than 500 nm. However, as shown in the test results to be described later, the interband transition is not necessarily the element to express the advantageous effects of the present invention.

Test 2: Evaluation of the Coated Body by Irradiation of Visible Light Preparation of the Coated Body

The substrate a and the substrate b were washed and dried. Then, the coating composition was applied by an air sprayer onto each of the substrate surfaces heated at 55° C. with the coating amount of 12.5 g/m²; then, this was dried at room temperature. Next, depending on the sample, this was kept in an electric furnace in an air atmosphere at a prescribed temperature for 1 hour to form the coated body having a surface layer. The coated body thereby obtained was used as the testing body. The combinations of the substrates, the coating compositions, and the heating temperatures are summarized in Table 5. Here, the coated body 10 was obtained as follows. Namely, the coating composition C1 was applied to the substrate, dried at room temperature to form the surface layer, and then, the coating composition C8 was applied onto the surface layer and dried at room temperature to form the outermost surface layer. The conditions of application and drying in formation of the outermost surface layer were the same as those in formation of the surface layer.

TABLE 5

| | | | Coating | Heating temp. |
|---|---|---|---|---|
| Coated body | | Substrate | composition | [° C.] |
| 1 | Example | a | C1 | No (room temp.) |
| 2 | Example | a | C1 | 200 |
| 3 | Example | a | C1 | 400 |
| 4 | Comparative Example | b | C1 | 600 |
| 5 | Comparative Example | b | C1 | 850 |
| 6 | Example | a | C2 | No (room temp.) |
| 7 | Comparative Example | a | C3 | No (room temp.) |
| 8 | Example | a | C5 | No (room temp.) |
| 9 | Example | a | C6 | No (room temp.) |
| 10 | Example | a | C1: Surface | No (room temp.) |
| | | | layer | |
| | | | C8: | |
| | | | Outermost | |
| | | | layer | |
| 11 | Comparative Example | a | C7 | No (room temp.) |

Following tests 2(1) to 2(3) were carried out on the coated bodies in Table 5.

Test 2(1): ATP Value after Irradiation of Visible Light

The fungi (Nothophoma sp.) isolated from a field site were pre-cultured in a potato-dextrose agar slant medium at 28° C. for 7 to 14 days; then, spores obtained by pre-culturing were suspended in sterilized and purified water including 0.005% by weight of Tween 80, which was then followed by dilution with sterilized and purified water in such a way as to give spore's concentration of 1×10⁵/mL to obtain an inoculum liquid. This inoculum liquid was mixed with the same amount of a 10% Czapek-Dox liquid medium to obtain a mixed solution. After 0.1 mL of the mixed solution was dropped onto the surface of the coated body (cut to the size of 25 mm×25 mm) that had been previously sterilized by sterilizing lamp, this was smeared to cover the entire surface. The ATP value immediately after smearing was 70±20 RLU/cm². The processes from preparation of the inoculum liquid until smearinging were carried out within the same day as preparation of the inoculum liquid.

Next, the coated body smeared with the mixed solution was allowed to statically leave in a clean bench at 25° C. for 3 hours for drying. At this time, inside the clean bench was kept in the state of the air therein stirred with a fan. The coated body after dried was allowed to statically leave under the environment controlled at 28° C. and a relative humidity of 100% with irradiating the visible light with a wavelength of 400 nm or more passed through a UV-cut filter, using white fluorescence lamp as a light source (FLR40SW/M/36-B; manufactured by Hitachi Appliances, Inc.), at luminosity of 5000 lx (measured with IM-5: illuminometer manufactured by TOPCON TECHNOHOUSE Corp.) for 48 hours.

For quantification of ATP, an ATP wiping test system (manufactured by Kikkoman Corp.) was used. The surface of the coated body after irradiation with the visible light was wiped out with “Lucipac (registered trade mark) Pen” (manufactured by Kikkoman Corp.), and then, this was inserted into “Lumitester (registered trade mark) PD-30” (manufactured by Kikkoman Corp.) to measure the luminescence amount emitted from a luciferase-catalyzed reaction of luciferin, oxygen, and ATP; then, this amount was converted to the ATP value per unit area of the surface of the coated body.

Test 2(2): Spore's Survival Ratio after Irradiation of Visible Light

After 0.1 mL of the inoculum liquid obtained in the same way as Test 2(1) was dropped onto the surface of the coated body previously sterilized by sterilizing lamp (cut to the size of 25 mm×25 mm), this was smeared to cover the entire surface. Next, the coated body smeared with the inoculum liquid was allowed to statically leave in a clean bench at 25° C. for 3 hours for drying. At this time, inside the clean bench was kept in the state of the air therein stirred with a fan. The coated body after dried was allowed to statically leave under the environment controlled at 28° C. and a relative humidity of 100% with irradiating the visible light with a wavelength of 400 nm or more passed through a UV-cut filter, using white fluorescence lamp as a light source (FLR40SW/M/36-B; manufactured by Hitachi Appliances, Inc.), at luminosity of 5000 lx (measured with IM-5: illuminometer manufactured by TOPCON TECHNOHOUSE Corp.) for 24 hours.

The coated body after irradiation with the visible light was put in a Stomacher bag together with 4.5 mL a recovering solution (aqueous solution including 0.005% by weight of sodium dioctyl sulfosuccinate and 0.891% by weight of sodium chloride), which was then followed by ultrasonic irradiation using a ultrasonic cleaning apparatus (V-F100; manufactured by AS ONE Corp.) with output power of 100 W (50 kHz) for 5 minutes to recover the fungi and their spores from the surface of the coated body. Next, this recovered solution including the spores was mixed with 10% Czapek-Dox agar medium. After this was cultured at 28° C. for 7 days, colony forming number was taken as the number of surviving spores. The ratio of the number of surviving spores on the surface of the coated body to the number of surviving spores on the glass surface not having the antifungal activity (reference) was taken as the spore's survival ratio.

Test 2(3): Damage Ratio of Cell Membrane of Fungal Spores after Irradiation of Visible Light

After 0.1 mL of the inoculum liquid obtained in the same way as Test 2(1) was dropped onto the surface of the coated body previously sterilized by sterilizing lamp (cut to the size of 25 mm×25 mm), this was smeared to cover the entire surface. Next, the coated body smeared with the inoculum liquid was allowed to statically leave in a clean bench at 25° C. for 3 hours for drying. At this time, inside the clean bench was kept in the state of the air therein stirred with a fan. The coated body after dried was allowed to statically leave under the environment controlled at 28° C. and a relative humidity of 100% with irradiating the visible light of 400 nm or more passed through a UV-cut filter, using white fluorescence lamp as a light source (FLR40SW/M/36-B; manufactured by Hitachi Appliances, Inc.), at luminosity of 5000 lx (measured with IM-5: illuminometer manufactured by TOPCON TECHNOHOUSE Corp.) for 48 hours.

The nuclear dying kit (LIVE/DEAD™ FungaLight™ Yeast Viability Kit for flow cytometry; manufactured by Thermo Fisher Scientific Inc.) was used. SYTO9 and PI each were dissolved into sterilized and purified water so as to give the concentrations of 15 μM and 75 μM, respectively, to obtain the fluorescence dying solution. Onto the surface of the coated body treated with the operations described in the above paragraph (namely, the coated body obtained by inoculating the fungal spore to the sample, followed by drying and then irradiation), 50 μL of the fluorescence dying solution was dropped. After the sample dropped with the fluorescence dying solution was allowed to statically leave at 25° C. without a light for 30 minutes, the excess fluorescence dying solution was removed. Next, with irradiating the laser beams of 488 nm and 561 nm as the excitation lights to the surface of the coated body, the fluorescence emitted by each of the two nuclear dying reagents, i.e., a green fluorescence and a red fluorescence, were observed by using a confocal fluorescence microscope.

The observation was done with magnification of 340. Of the fungal spores observed, with excluding those in the stages of germination and mycelial growth, the numbers of the spores emitting the green fluorescence and of the spores emitting the red fluorescence were measured respectively; then, the total number thereof was used as the total spore number. The spores emitting the red fluorescence were considered “membrane damaged”, and the ratio of the number of the spores with “membrane damaged” to the total spore number was calculated to obtain the damage ratio of cell membrane.

Results of Tests 2(1) to 2(3) are summarized in Table 6.

TABLE 6

| | | Evaluation of coated body after | | |
|---|---|---|---|---|
| | | irradiation of visible light | | |
| | | | Spore's | Damage ratio |
| | | ATP | survival | of cell |
| | | value | ratio | membrane |
| Coated body | | (RLU/cm²) | (%) | (%) |
| 1 | Example | 120 | 97 | 0 |
| 2 | Example | 379 | 73 | 0 |
| 3 | Example | 387 | 64 | 0 |
| 4 | Comparative Example | 1338 | 98 | 0 |
| 5 | Comparative Example | 2462 | 64 | 0 |
| 6 | Example | 380 | 89 | 0 |
| 7 | Comparative Example | 1531 | 98 | 7 |
| 8 | Example | 402 | 98 | 0 |
| 9 | Example | 398 | 95 | 0 |
| 10 | Example | 123 | 98 | 7 |
| 11 | Comparative Example | 10569 | 97 | 5 |

Test 3: Evaluation of the Coated Body by Irradiation of Light Including UV Light Preparation of the Coated Body

By using the same coated body as Test 2, following evaluations were carried out.

Test 3(1): ATP Value after Irradiation of Light Including UV Light

After 0.1 mL of the mixed solution prepared in the same way as Test 2(1) was dropped onto the surface of the coated body previously sterilized by sterilizing lamp (cut to the size of 25 mm×25 mm), this was smeared to cover the entire surface. Next, the coated body smeared with the mixed solution was allowed to statically leave in a clean bench at 25° C. for 3 hours for drying. At this time, inside the clean bench was kept in the state of the air therein stirred with a fan. The coated body after dried was allowed to statically leave under the environment controlled at 28° C. and a relative humidity of 100% with irradiating BLB lamp as a light source (FL40SBLB; manufactured by Sankyo Electronics Co., Ltd.) at the UV strength of 0.5 mW/cm² (measured with UVR-2: UV strength measurement instrument manufactured by TOPCON TECHNOHOUSE Corp.) for 48 hours.

Next, quantification of the ATP value on the surface of the coated body after irradiation of the light including the UV light was carried out in the same way as quantification of the ATP value in Test 2(1).

Test 3(2): Spore's Survival ratio after Irradiation of Light Including UV Light After 0.1 mL of the inoculum liquid obtained in the same way as Test 2(1) was dropped onto the surface of the coated body previously sterilized by sterilizing lamp (cut to the size of 25 mm×25 mm), this was smeared to cover the entire surface. Next, the coated body smeared with the inoculum liquid was allowed to statically leave in a clean bench at 25° C. for 3 hours for drying. At this time, inside the clean bench was kept in the state of the air therein stirred with a fan. The coated body after dried was allowed to statically leave under the environment controlled at 28° C. and a relative humidity of 100% with irradiating BLB lamp as a light source (FL40SBLB; manufactured by Sankyo Electronics Co., Ltd.) at the UV strength of 0.5 mW/cm² (measured with UVR-2: UV strength measurement instrument manufactured by TOPCON TECHNOHOUSE Corp.) for 24 hours.

Operation after irradiation and the calculation of the spore's survival ratio were done in the same way as Test 2(2).

Test 3(3): Damage Ratio of Cell Membrane of Fungal Spores after Irradiation of Light Including UV Light

After 0.1 mL of the inoculum liquid obtained in the same way as Test 2(1) was dropped onto the surface of the coated body previously sterilized by sterilizing lamp (cut to the size of 25 mm×25 mm), this was smeared to cover the entire surface. Next, the coated body smeared with the inoculum liquid was allowed to statically leave in a clean bench at 25° C. for 3 hours for drying. At this time, inside the clean bench was kept in the state of the air therein stirred with a fan. The coated body after dried was allowed to statically leave under the environment controlled at 28° C. and a relative humidity of 100% with irradiating BLB lamp as a light source (FL40SBLB; manufactured by Sankyo Electronics Co., Ltd.) at the UV strength of 0.5 mW/cm² (measured with UVR-2: UV strength measurement instrument manufactured by TOPCON TECHNOHOUSE Corp.) for 48 hours.

Operation after irradiation, the observation, and the calculation of the damage ratio of cell membrane were done in the same way as Test 2(3).

The results of Test 3(1) to Test 3(4) are summarized in Table 7.

TABLE 7

| | | Evaluation of coated body after | | |
|---|---|---|---|---|
| | | irradiation of light including UV light | | |
| | | | Spore's | Damage ratio |
| | | ATP | survival | of cell |
| | | value | ratio | membrane |
| Coated body | | (RLU/cm²) | (%) | (%) |
| 1 | Example | 34 | 97 | 15 |
| 2 | Example | 26 | 77 | 2 |
| 3 | Example | 42 | 78 | 13 |
| 4 | Comparative Example | 714 | 68 | 9 |
| 5 | Comparative Example | 3505 | 99 | 26 |
| 6 | Example | 34 | 77 | 25 |
| 7 | Comparative Example | 1531 | 67 | 54 |
| 8 | Example | 230 | 93 | 6 |
| 11 | Comparative Example | 7 | 2 | 96 |

Test 4: Evaluation of Antifungal and Anti-Algal Properties by Outdoor Exposure Preparation of the Coated Body

After the substrate c was washed and dried, the coating composition was applied by an air sprayer onto the substrate surface heated at 55° C. with the coating amount of 12.5 g/m²; then, this was dried at room temperature to obtain the coated body. Separately from this, after the substrate b was washed and dried, the coating composition was applied by an air sprayer onto the substrate surface heated at 55° C. with the coating amount of 12.5 g/m²; then, this was dried at room temperature, and then heated at 850° C. for 1 hour in an electric furnace to obtain the coated body. The coated bodies thereby obtained were used as the testing body. The combinations of the substrates, the coating compositions, and the heating temperatures are described in Table 8.

TABLE 8

| | | | Coating | Heating temp. |
|---|---|---|---|---|
| Coated body | | Substrate | composition | [° C.] |
| 12 | Example | c | C1 | No (room temp.) |
| 13 | Example | c | C1 | 200 |
| 14 | Example | b | C1 | 400 |
| 15 | Comparative Example | b | C1 | 850 |
| 16 | Example | c | C2 | No (room temp.) |
| 17 | Example | c | C5 | No (room temp.) |
| 18 | Example | c | C6 | No (room temp.) |

The environment surrounded by forest in Tokai district was chosen as the exposure test site. The coated bodies described in Table 8 were placed toward a north direction.

The exposure test to evaluate the antifungal effect was carried out for 3 months.

The effect after termination of the exposure test was confirmed from appearance with visual observation as well as with observation by a reflection illumination microscope (ECLIPSE LV100ND, manufactured by Nikon Corp.); the states of germination of the fungal spores and extension of the mycelia were observed with magnification of 340. Evaluation of the antifungal effect was done in accordance with the following standards expressed by scores.

0: Neither fouling due to fungi can be visually recognized, nor can be recognized germination of fungal spore by microscopic observation.

1: Fouling due to fungi cannot be visually recognized, but germination can be observed in part of fungi by microscopic observation.

2: Not only black fouling due to fungi can be visually recognized, but also most of the fungal spores are germinated and the mycelia are extended more than 100 μm by microscopic observation.

The scores of 0 and 1 were judged to be effective in an antifungal activity; the score of 2 was judged to be ineffective in an antifungal activity.

The exposure test to evaluate the anti-algal effect was carried out for 1 year.

Evaluation of the anti-algal effect after termination of the exposure test was done with visual observation in accordance with the following standards expressed by scores.

0: Fouling due to algae cannot be visually recognized. 1: Fouling due to algae can be visually recognized, but the change to green cannot be recognized.

2: Not only fouling due to algae can be visually recognized clearly, but also the change to green can be recognized.

The scores of 0 and 1 were judged to be effective in anti-algal activity; the score of 2 was judged to be ineffective in anti-algal activity.

The exposure test results in evaluation of the antifungal effect and the anti-algal effect are summarized in Table 9.

TABLE 9

| | | Antifungal | Anti-algal |
|---|---|---|---|
| Coated body | | effect | effect |
| 12 | Example | 0 | 0 |
| 13 | Example | 0 | 0 |
| 14 | Example | 1 | 1 |
| 15 | Comparative Example | 2 | 2 |
| 16 | Example | 1 | 1 |
| 17 | Example | 1 | 1 |
| 18 | Example | 0 | 0 |

In Examples, mycelial growth of the fungal spores was effectively suppressed, and the black fouling due to the fungal growth could not be visually recognized; so, the excellent antifungal effect could be expressed. Also, the green fouling due to the algae could not be visually recognized; so, the excellent anti-algal effect could be expressed.

Test 5: Relationship Between ATP Value and Fungal Growth Test 5(1): Relationship Between ATP Value and Fungal Growth in Laboratory Evaluation

The coating composition C8 was applied by an air sprayer onto the surface of the substrate c heated at 55° C. with the coating amount of 12.5 g/m²; then, this was dried at room temperature to form a surface layer. The coated body thereby obtained (coated body 19) was used for evaluation. After 0.1 mL of the mixed solution obtained in the same way as Test 2(1) was dropped onto the coated body previously cut to the size of 25 mm×25 mm and sterilized by sterilizing lamp, this was smeared to cover the entire surface. The coated body thus smeared was allowed to statically leave under dark condition in the environment controlled at 28° C. and a relative humidity of 100% to culture the fungi. Evaluation of the growth degree of the fungi and quantification of the ATP value on the coated body were done with cultivation time of 0 hour, 17 hours, 24 hours, and 40 hours, respectively.

Quantification of the ATP value was done in the same way method as the method described in Test 2(1) Quantification of ATP Value.

Growth degree of the fungi was evaluated by observation of the states of germination of the fungal spores and of extension of the mycelia by using a reflection illumination microscope (ECLIPSE LV100ND, manufactured by Nikon Corp.) in a view field with magnification of 340 in accordance with the following 4 classified stages with regard to the mycelial growth degree. Typical states of the fungal growth in these stages are shown in FIG. 1 to FIG. 4, respectively.

(Mycelial Growth Degree)

0: Spores are not germinated (FIG. 1)

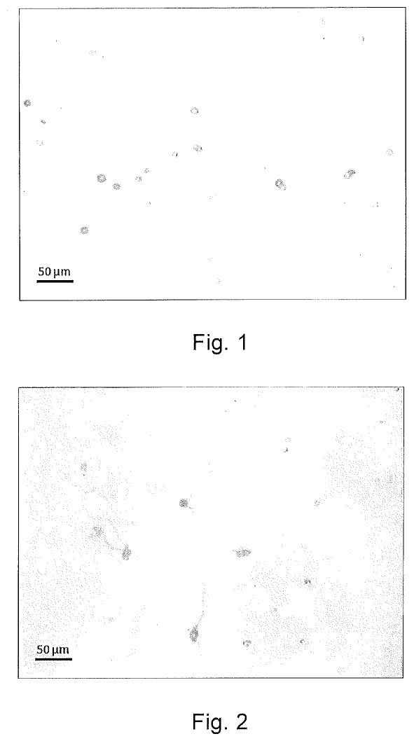

1: Part of spores is germinated, but the length of the mycelia is short (several 10 to several 100 μm (FIG. 2)

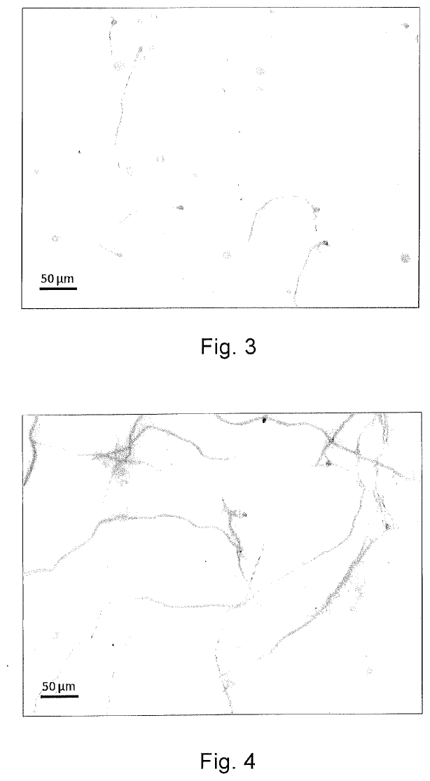

2: Germination of spores is recognized, and the mycelia partially extend more than several 100 μm (FIG. 3)

3: Most of spores are germinated, and the mycelia extend entirely (FIG. 4) In the mycelial growth degree of 3, a darkish sample surface due to the fungal growth or a black fouling due to the fungi can be recognized even with visual observation.

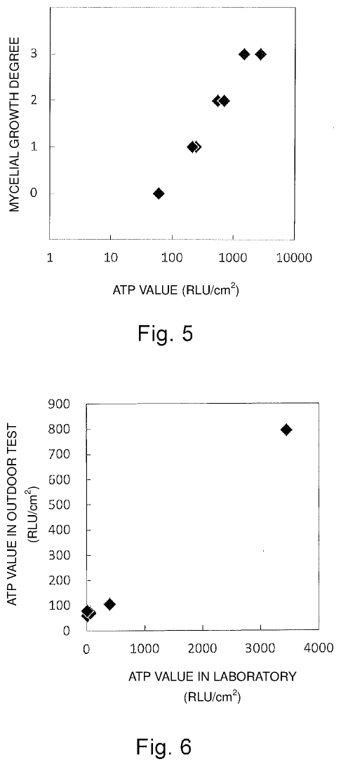

Relationship between the ATP value and the mycelial growth degree is illustrated in FIG. 5.

There was a high correlation between the ATP value and the mycelial growth degree, namely the higher the ATP value was, the longer the fungal mycelia extended. It was found that the ATP value corresponds to the growth degree of the fungi, from the state of spore, germination, until mycelial growth.

Test 5(2): Relationship Between ATP Value after Laboratory Test and ATP Value after Outdoor Exposure Test

In order to compare the ATP values between the laboratory test and the outdoor exposure test, the coating compositions C1, C5, C7, and C8, as well as C9 were used. The coating composition C9 was obtained by mixing a water-dispersion body of the rutile-type titanium oxide particle, a water-dispersion type colloidal silica, a dispersing medium, and an additive agent. The concentration of the layer-forming components in the coating composition C9 was made to 5.5% by mass. The content of the silica particles was made to 90 parts by mass relative to 10 parts by mass of the rutile-type titanium oxide particles. By using these coating compositions, five coated bodies having the surface layers with different compositions were prepared. The preparation conditions of the coated bodies were the same as those of Test 5(1). Correspondences between the coated bodies and the used coating compositions are described in Table 10.

TABLE 10

| Coated body | Coating composition |
|---|---|
| 19 | C8 |
| 20 | C1 |
| 21 | C5 |
| 22 | C7 |
| 23 | C9 |

The outdoor exposure test was carried out in the same exposure site as the Test 4 by exposing for 1 month to measure the ATP value.

The laboratory test was carried out by the following procedure. Namely, after 0.1 mL of the mixed solution prepared in the same way as Test 2(1) was dropped onto the coated body previously cut to the size of 25 mm×25 mm and sterilized by a sterilizing lamp, this was smeared to cover the entire surface. The coated body thus smeared was allowed to statically leave under the environment controlled at 28° C. and a relative humidity of 100% with irradiating BLB lamp (FL40SBLB; manufactured by Sankyo Electronics Co., Ltd.) at the UV strength of 0.5 mW/cm² (measured with UVR-2: UV strength measurement instrument manufactured by TOPCON TECHNOHOUSE Corp.) with an interval of 12 hours. After irradiation and non-irradiation were done for total 48 hours, the ATP value was quantified.

Quantification of the ATP value was done in the same way method as the quantification method of the ATP value described in Test 2(1).

The relationship between the ATP value after the laboratory test and the ATP value after the outdoor exposure test is illustrated in FIG. 6.

In all of the coated body's surfaces after the one-month outdoor test, attachment and growth of algae were not recognized; only attachment and germination of the fungal spores and extension of the mycelia thereof were recognized. The ATP value recognized in the laboratory test showed a high correlation with the ATP value after the outdoor exposure test.

The coated body 19 showed eminently high ATP values in both the laboratory test and the outdoor test. On the other hand, the ATP values were low in other 4 samples in both the tests; the order of the ATP value in the laboratory test was almost the same as that of the outdoor exposure test (coated body 19>>coated body 23>coated body 20>coated body 22≈coated body 21).

The ATP value is an effective index to show the antifungal effect; so, this can be used as the index to see the degree of the effect of the coated body's surface on the fungal spores. The coated body's surface capable of suppressing the ATP value can effectively express the antifungal effect.

Test 6: Relationship Between Fungal Growth (ATP Value) and Algal Growth

The relationship between the ATP value in the laboratory test and the algal growth in the outdoor exposure test was evaluated. The same 5 coated bodies as those used in the Test 5(2) were used. The exposure test of Test 5(2) was extended to 6 months, and the temporal observation during this period and the degree of the color change due to fouling after 6 months were evaluated.

Measurement of the ATP value was done in the same way as the laboratory test in Test 5(2) except for the irradiation conditions. The irradiation conditions were as follows.

The BLB lamp (FL40SBLB; manufactured by Sankyo Electronics Co., Ltd.) and the white fluorescence lamp (FLR40SW/M/36-B; manufactured by Hitachi Appliances, Inc.) were irradiated for 12 hours simultaneously. The UV strength on the coated body's surface measured with UVR-2 (UV strength measurement instrument; manufactured by TOPCON TECHNOHOUSE Corp.) was 0.5 mW/cm², and the luminosity on the coated body's surface measured with IM-5 (illuminometer; manufactured by TOPCON TECHNOHOUSE Corp.) was 5000 lx. This irradiation was followed by the dark period of 12 hours; then, the intermittent irradiation with the interval of 12 hours was carried out.

In the temporal observation, at the passage of 1 month of the exposure, on the coated body corresponding to Comparative Example, it was observed that the fungal spores germinated and that the mycelia extended to the entire surface; but attachment of the algae was not recognized. In this test, in the coated body corresponding to Comparative Example, attachment of the algae started after extension of the fungal mycelia; then, this was resulted in visual recognition of a greenish fouling at the passage of 6 months.

Evaluation of the fouling degree at the passage of 6 months was done by using a spectrophotometric colorimeter (CM-2600d; manufactured by KONICA MINOLTA JAPAN, Inc.). In accordance with JIS Z8730 (2009), this was quantified as the color difference ΔE* on the coated body's surface between before the outdoor exposure test and at the passage of 6 months in the L*a*b* color system.

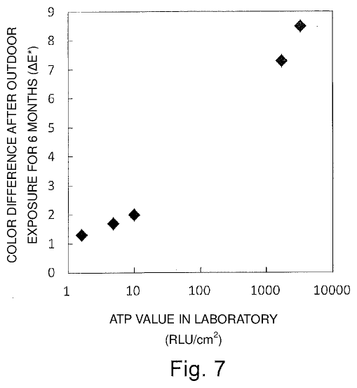

The relationship between the ATP value in the laboratory test and the color difference after the outdoor exposure test is illustrated in FIG. 7.

According to FIG. 7, a good correlation can be seen between the ATP value and the color difference.

It can be seen that the coated body capable of suppressing the ATP value is effective not only in design of the antifungal effect but also in design of the anti-algal effect. Considering the above findings and the developing process of the fouling in the outdoor exposure test, there is a close relationship between the antifungal effect and the anti-algal effect; so, it is presumed that to suppress germination of the fungal spores and extension of the mycelia is important to express the excellent anti-algal effect. Therefore, it can be said that the ATP value is effective not only as the index of the effect of the coated body's surface on the fungal spores, namely, as the index of the antifungal effect, but also as the index of the anti-algal effect.

Test 7: Raman Spectroscopic Measurement of the Coated Body

The coated bodies described in Table 5 were subjected to the Raman spectroscopic measurement. The measurement conditions were as follows.

Instrument: RAMANTouch (manufactured by Nanophoton Corp.)

Laser wavelength: 532 nm

Laser output: the laser output was controlled such that the scattering strength of the F_{2g} vibration mode of the Ce—O bond might be as high as possible (higher than 3000 cps) within the range not beyond the upper measurable limit.

Pin-hole size: 50 μm

Diffraction grating: 2400 gr/mm

Center wavenumber: 460 cm⁻¹

Irradiation time: 300 seconds

Accumulation number: once

Objective lens: TU Plan Fluorx100 (NA: 0.90)

Identification of Wavenumber of the Peak Attributed to F_{2g} Vibration Mode of Ce—O Bond

When the amount of cerium oxide in the sample is smaller, and when the cerium oxide has more oxygen defects, the peak obtained becomes wider, thereby occasionally leading to unclear wavenumber of the peak. Therefore, in the present invention, the wavenumber attributed to this peak was done as follows.

1) In the same sample, 5 locations were measured.

2) In each of these measurement results, the wavenumber range in which the strength of 95% or more relative to the maximum strength in the range of 450 to 470 cm⁻¹ was identified; the center wavenumber thereof was calculated, and this was taken as the center wavenumber of this peak. Here, the wavenumber range in which the strength of 95% or more can be obtained was determined by taking the minimum wavenumber giving the strength of 95% or more and the maximum wavenumber giving the strength of 95% or more as the both ends. The Raman spectrum obtained has a certain width due to the noise. Therefore, there is a chance to have, within this wavelength range, a point where the strength is less than 95%. In this case, the wavelength range was determined with including the point where the strength was less than 95%.

3) Of the center wavenumbers of the peak obtained from the measurement results of the 5 locations, the maximum value and the minimum value were removed; and the average value of 3 locations was taken as the wavenumber of the peak attributed to the F_{2g} vibration mode of the Ce—O bond in the sample.

The shift toward a lower wavenumber was measured as the difference between the wavenumber of the detected peak attributed to the F_{2g} vibration mode of the Ce—O bond thereof obtained by measurement of a standard substance (cerium oxide manufactured by Kojundo Chemical Laboratory Co., Ltd.; catalogue No.: CEO04PB, Lot No.: 4702411) and the wavenumber of the peak attributed to the same mode obtained by measurement of the coated body.

These results are shown in Table 11.

TABLE 11

| | Raman spectrophotometry |
|---|---|
| | measurement result |
| | Shift of peak attributed |
| | to F_{2 g} vibration mode of |
| | Ce—O bond toward lower |
| Coated body | wavenumber(cm⁻¹) |

| | | |
|---|---|---|
| 1 | Example | 8.6 |
| 2 | Example | 8 |
| 3 | Example | 6.1 |
| 4 | Comparative Example | 1.4 |
| 5 | Comparative Example | 0.6 |
| 6 | Example | 2.7 |
| 7 | Comparative Example | 1.2 |
| 8 | Example | 8.3 |
| 9 | Example | 7.8 |
| 10 | Example | 5.1 |
| 11 | Comparative Example | 0 |

1. A coated body for use in suppressing growth of fungi and/or algae attached to a surface thereof, which comprises:
a substrate and a surface layer formed on the substrate;
wherein the surface layer comprises a cerium oxide particles having an oxygen-deficient fluorite structure and having an average crystallite diameter thereof in a range of 10 nm or less; and the cerium oxide particles have, in a Ramanspectrum, a peak attributed to an F_{2g} vibration mode of a Ce—O bond is shifted toward a lower wavenumber by more than 2 cm⁻¹ from a peak attributed to the F_{2g} vibration mode of the Ce—O bond obtained by measurement of a standard substance; and
wherein the surface layer suppresses growth of the fungi and/or the algae attached to a surface of the coated body.

2. The coated body according to claim 1, wherein the cerium oxide particles further have a peak attributed to O₂²⁻ in the Raman spectrum thereof.

3. The coated body according to claim 1 or 2, which is used under an environment in which a visible light is irradiated to the surface layer, and fungal spores attach to the surface thereof.

4. The coated body according to claim 3, having characteristics that a damage ratio of cell membrane of the fungal spores after irradiation of the visible light is less than 10%, and an ATP value after irradiation of the visible light is in the range of more than 0 to less than 1000 RLU/c m².

5. (canceled)

6. The coated body according to claim 3, wherein a spore's survival ratio after irradiation of the visible light is more than 50%.

7. The coated body according to claim 1, which is used under an environment in which light including UV light is irradiated to the surface layer, and fungal spores attach to the surface thereof.

8. The coated body according to claim 7, having characteristics that a damage ratio of cell membrane of the fungal spores after irradiation of the light including the UV light is less than 50%, and an ATP value after irradiation of the light including the UV light is in the range of more than 0 to less than 500 RLU/cm².

9. (canceled)

10. The coated body according to claim 7, wherein the spore's survival ratio after irradiation of the light including the UV light is more than 50%.

11. The coated body according to claim 1, wherein the surface layer further comprises silica particles.

12. (canceled)

13. The coated body according to claim 1, wherein the surface layer has a porous structure through which the fungi and/or the algae cannot pass.

14. A coating composition, which comprises a cerium oxide particles having an oxygen-deficient fluorite structure and having an average crystallite diameter thereof in a range of 10 nm or less;
wherein the cerium oxide particles have, in a Raman spectrum, a peak attributed to an F_{2g} vibration mode of a Ce—O bond is shifted toward a lower wavenumber by more than 2 cm⁻¹ from a peak attributed to the F_{2g} vibration mode of the Ce—O bond obtained by measurement of a standard substance; and
wherein a coated body which comprises a surface layer having the coating composition coated on a substrate suppresses growth of fungi and/or algae attached to a surface of the coated body.

15. The coating composition according to claim 14, wherein the cerium oxide particles further have a peak attributed to O₂²⁻ in the Raman spectrum thereof.

16. The coating composition according to claim 14, wherein the coated body is used under an environment in which a visible light is irradiated to the surface layer, and fungal spores attach to the surface thereof.

17. The coating composition according to claim 16, having characteristics that in the coated body a damage ratio of cell membrane of the fungal spores after irradiation of the visible light is less than 10%, and an ATP value after irradiation of the visible light is in the range of more than 0 to less than 1000 RLU/cm².

18. (canceled)

19. The coating composition according to claim 16, wherein in the coated body a spore's survival ratio after irradiation of the visible light is more than 50%.

20. The coating composition according to claim 14, wherein the coated body is used under an environment in which light including UV light is irradiated to the surface layer, and fungal spores attach to the surface thereof.

21. The coating composition according to claim 20, wherein the coated body has characteristics that a damage ratio of cell membrane of the fungal spores after irradiation of the light including the UV light is less than 50%, and an ATP value after irradiation of the light including the UV light is in the range of more than 0 to less than 500 RLU/cm².

22. (canceled)

23. The coating composition according to claim 20, wherein the coated body has the characteristics that the spore's survival ratio after irradiation of the light including the UV light is more than 50%.

24. The coating composition according to claim 14, wherein the coating composition further comprises silica particles.

25. (canceled)

26. The coating composition according to claim 14, wherein the coating composition further comprises a dispersing medium.

27-34. (canceled)
